(19) United States
(12) Patent Application Publication
(10) Pub. No.: US 2006/0165918 A1
(43) Pub. Date: Jul. 27, 2006

(54) Polarizing plate having optically anisotropic layer formed from liquid crystal molecules

(75) Inventor: Yoji Ito, Minami-ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fuji Photo Flim Co., Ltd., Minami-ashigara-shi (JP)

(21) Appl. No.: 10/521,177

(22) PCT Filed: Jul. 17, 2003
(86) PCT No.: PCT/JP03/09098

§ 371 Date: Jan. 14, 2005

(30) Foreign Application Priority Data
Jul. 17, 2002 (JP) 2002-208822

(51) Int. Cl. C09K 19/00

(52) U.S. Cl. 428/1.31; 428/1.3

(57) ABSTRACT

A polarizing plate has a polarizing membrane and an optically anisotropic layer formed from liquid crystal molecules. The optically anisotropic layer is formed on the polarizing membrane, or formed on an orientation layer that is formed on the polarizing membrane.

### FIELD OF INVENTION

The present invention relates to a polarizing plate comprising a polarizing membrane and an optically anisotropic layer formed from liquid crystal molecules.

### BACKGROUND OF INVENTION

A liquid crystal display generally comprises a polarizing plate and a liquid crystal cell.

The most widely used display is a TFT liquid crystal display of TN mode, in which an optical compensatory sheet is provided between the polarizing plate and the liquid crystal cell. Because of the compensatory sheet, the display gives images with high qualities but is often thick and heavy.

Japanese Patent provisional Publication No. 1(1989)-68940 discloses an elliptically polarizing plate in which a polarizing membrane is provided between a phase retarder and a protective film. According to the publication, the elliptically polarizing plate can improve front contrast without thickening the display. However, the retarder (optical compensatory sheet) has poor thermal durability and is liable to be thermally distorted to cause undesired phase difference. The phase difference makes the display give an image framed with leaked light (namely, it framewise increases transmittance of the screen of display), and consequently impairs the quality of displayed image.

To solve the problem, Japanese Patent Provisional Publication No. 7(1995)-191217 and European Patent No. 0911656A2 propose a liquid crystal display in which an optical compensatory sheet comprising a transparent support coated with an optically anisotropic layer formed from discotic liquid crystal molecules is directly used as a protective film of the polarizing plate. The proposed display has improved thermal durability and thin thickness.

Hitherto the optical compensatory sheet has been developed on the assumption that the size of display is 15 inches or less, but recently it has been getting necessary to take account of a large liquid crystal display of 17-inches or more.

It is found that, even if a polarizing plate equipped with the known optical compensatory sheet as the protective film is attached on a large display, the framewise light leakage caused by thermal distortion is not prevented. With respect to a small or medium liquid crystal display of 15 inches or less, the known compensatory sheet inhibits the light leakage caused by thermal distortion. Accordingly, the compensatory sheet should be further improved in the durability against fluctuation of environmental conditions (i.e., temperature and humidity).

### SUMMARY OF INVENTION

It is an object of the present invention to optically compensate a liquid crystal cell by means of a polarizing plate having optical compensating function.

It is another object of the invention to make even a large liquid crystal display give an image of high quality without causing troubles such as light leakage.

The objects of the invention are achieved by the polarizing plates (1) to (21), the liquid crystal display (22) and the processes for preparation of the liquid crystal display (23) and (24) described below.

(1) A polarizing plate comprising a polarizing membrane and an optically anisotropic layer formed from liquid crystal molecules, wherein the optically anisotropic layer is formed (directly) on the polarizing membrane, or wherein an orientation layer is formed (directly) on the polarizing membrane, and the optically anisotropic layer is formed (directly) on the orientation layer.

(2) The polarizing plate of (1), wherein the liquid crystal molecules contained in the optically anisotropic layer are rod-like liquid crystal molecules whose long axes are oriented at an angle of more than 5° on average to a surface of the polarizing membrane.

(3) The polarizing plate of (2), wherein the long axes of the rod-like liquid crystal molecules are oriented at an angle of less than 5° on average to a transmission axis of the polarizing membrane.

(4) The polarizing plate of (1), wherein the liquid crystal molecules contained in the optically anisotropic layer are discotic liquid crystal molecules whose long axes (discotic planes) are oriented at an angle of less than 5° on average to a surface of the polarizing membrane.

(5) The polarizing plate of (1), wherein the thickness of the polarizing membrane is 20 μm or less.

(6) The polarizing plate of (1), further comprising a light-diffusing layer.

(7) The polarizing plate of (1), further comprising an anti-reflection layer.

(8) The polarizing plate of (7), wherein a transparent support having a thickness of 70 μm or less is furthermore provided and the anti-reflection layer is provided thereon.

(9) The polarizing plate of (1), wherein the optically anisotropic layer comprises a first optically anisotropic layer provided on the polarizing membrane side and a second optically anisotropic sub-layer provided thereon, and long axes of the liquid crystal molecules contained in the first sub-layer are oriented at an angle of more than 10° on average to a direction in which long axes of the liquid crystal molecules in the second sub-layer are oriented on average.

(10) The polarizing plate of (9), wherein the liquid crystal molecules contained in the first optically anisotropic sub-layer are rod-like liquid crystal molecules whose long axes are oriented on average at an angle of less than 5° to a surface of the polarizing membrane.

(11) The polarizing plate of (10), wherein the long axes of the rod-like liquid crystal molecules are oriented at an angle of less than 5° on average to a transmission axis of the polarizing membrane.

(12) The polarizing plate of (10), wherein the liquid crystal molecules contained in the second optically anisotropic sub-layer are rod-like liquid crystal molecules whose long axes are oriented at an angle of more than 15° on average to the surface of the polarizing membrane, and the angle between the long axis of each molecule and the surface of the polarizing membrane varies according to the distance between the molecule and the membrane.

(13) The polarizing plate of (10), wherein the liquid crystal molecules contained in the second optically anisotropic sub-layer are discotic liquid crystal molecules whose long axes (discotic planes) are oriented at an angle of more than 15° on average to the surface of the polarizing membrane, and the angle between the long axis (discotic plane) of each molecule and the surface of the polarizing membrane varies according to the distance between the molecule and the membrane.

(14) The polarizing plate of (11), wherein the liquid crystal molecules contained in the second optically anisotropic sub-layer are rod-like liquid crystal molecules whose long axes are oriented at an angle of less than 5° on average to the surface of the polarizing membrane, and the long axes are also oriented at an angle of less than 5° on average to a transmission axis of the polarizing membrane.

(15) The polarizing plate of (10), wherein the liquid crystal molecules contained in the second optically anisotropic sub-layer are discotic liquid crystal molecules whose long axes (discotic planes) are oriented at an angle of more than 85° on average to the surface of the polarizing membrane.

(16) The polarizing plate of (9), wherein the liquid crystal molecules contained in the first optically anisotropic sub-layer are discotic liquid crystal molecules whose long axes (discotic planes) are oriented at an angle of more than 5° on average to the surface of the polarizing membrane.

(17) The polarizing plate of (16), wherein the liquid crystal molecules contained in the second optically anisotropic sub-layer are rod-like liquid crystal molecules whose long axes are oriented at an angle of more than 15° on average to the surface of the polarizing membrane, and the angle between the long axis of each molecule and the surface of the polarizing membrane varies according to the distance between the molecule and the membrane.

(18) The polarizing plate of (16), wherein the liquid crystal molecules contained in the second optically anisotropic sub-layer are discotic liquid crystal molecules whose long axes (discotic planes) are oriented at an angle of more than 15° on average to the surface of the polarizing membrane, and the angle between the long axis (discotic plane) of each molecule and the surface of the polarizing membrane varies according to the distance between the molecule and the membrane.

(19) The polarizing plate of (16), wherein the liquid crystal molecules contained in the second optically anisotropic sub-layer are rod-like liquid crystal molecules whose long axes are oriented at an angle of less than 5° on average to the surface of the polarizing membrane.

(20) The polarizing plate of (19), wherein the long axes of the rod-like liquid crystal molecules are oriented at an angle of less than 5° on average to a transmission axis of the polarizing membrane.

(21) The polarizing plate of (9), wherein the first optically anisotropic layer functions as an orientation layer of the second optically anisotropic layer.

(22) A liquid crystal display comprising a liquid crystal cell and a polarizing plate, wherein the polarizing plate is one of those defined in (1) to (20).

(23) A process for preparation of a polarizing plate comprising a polarizing membrane and an optically anisotropic layer, which comprises a step of coating a coating solution containing liquid crystal molecules on a surface of the polarizing membrane to form the optically anisotropic layer.

(24) A process for preparation of a polarizing plate comprising a polarizing membrane and an optically anisotropic layer, which comprises steps of forming an orientation layer on a surface of the polarizing membrane and coating a coating solution containing liquid crystal molecules on a surface of the orientation layer to form the optically anisotropic layer.

The long axis of rod-like liquid crystal molecule corresponds to a direction giving the maximum refractive index of the molecule. The long axis of discotic liquid crystal molecule corresponds to the (discotic) plane giving the maximum refractive index of the molecule.

The applicant has succeeded in both optically compensating a liquid crystal cell and preventing the display from framewise leaking light, by means of a polarizing plate comprising a polarizing membrane and an optically anisotropic layer (preferably consisting of two or more sub-layers different in the average direction of long axes of liquid crystal molecules oriented in each sub-layer).

The optically anisotropic layer formed from liquid crystal molecules is used for optically compensating a liquid crystal cell. In general, a polymer film (cellulose acetate film if used as the protective film in the polarizing plate) is coated with the optically anisotropic layer to produce an optical compensatory sheet comprising the anisotropic layer and the polymer film (transparent support).

In installing the optical compensatory sheet in a liquid crystal display, the sheet is usually fixed with adhesive on the liquid crystal cell. Accordingly, if the polymer film used in the sheet expands or shrinks, the expansion or shrinkage is limited as a whole to cause distortion by which the optical characters of the film are changed.

It has been thought that, when temperature and humidity (environmental conditions) under which the liquid crystal display is used are changed, the polymer film expands or shrinks to change the optical characters of the compensatory sheet. Further, it has been also suggested that thermal distribution is caused in the sheet by heat (for example, generated at a backlight) to distort the film and to change the optical characters.

Furthermore, it has been already known that a polymer having hydroxyl group such as cellulose acetate is considerably affected with the change of temperature and humidity.

Therefore, in order to prevent the light leakage, it is desired to completely protect the polymer film from distortion or, radically, not to use the polymer film itself.

A polarizing plate generally comprises a pair of protective films and a polarizing membrane mainly made of polyvinyl alcohol. According to the applicant's study, when the environmental conditions are changed, the polyvinyl alcohol used in the membrane changes its dimension to the highest degree.

Since the polarizing plate is laminated on the liquid crystal cell with adhesive, the dimension change causes distortion stress applied on the protective film (i.e., optical compensatory sheet). As a result, the distortion stress changes the optical characters of the protective film (i.e., optical compensatory sheet).

Accordingly, it is desired to reduce the stress (distortion×sectional area×modulus of elasticity) caused by the dimension change of the polarizing membrane. In detail, it is desired to make the polarizing plate thinner and/or to reduce the dimension change (distortion) caused by the environmental conditions.

The applicant has succeeded in providing an optically anisotropic layer formed from liquid crystal molecules on the polarizing membrane directly or otherwise in providing an orientation layer between them. In detail, a coating solution containing the liquid crystal molecules is applied on a surface of the membrane to form the anisotropic layer, and thereby a thin polarizing plate can be produced without providing a polymer film between the membrane and the anisotropic layer. In the thus-produced polarizing plate of the invention, the stress (distortion×sectional area×modulus of elasticity) caused by the dimension change of the polarizing membrane is small. Accordingly, a large liquid crystal display equipped with the polarizing plate of the invention gives an image of high quality without causing troubles such as the light leakage.

The polymer film used in the conventional plate has optical anisotropy. For making up for that, it is preferred that the optically anisotropic layer in the plate of the invention consist of two or more sub-layers formed from liquid crystal molecules and that one of them (preferably, sub-layer on the membrane side) have the same optical anisotropy as the polymer film.

### DETAILED DESCRIPTION OF INVENTION

(Optically Anisotropic Layer)

The optically anisotropic layer is preferably designed so that it can compensate the orientation of liquid crystal molecules in the liquid crystal cell when a black image is displayed. The orientation of liquid crystal molecules in displaying a black image depends on the mode of display, and is described in IDW'00, FMC7-2, pp. 411 to 414.

A preferred embodiment of the optically anisotropic layer in each mode is described below.

(Liquid Crystal Display of TN Mode)

A liquid crystal cell of TN mode is widely used in color TFT liquid crystal displays, and hence is described in many publications.

In the liquid crystal cell of TN mode displaying a black image, rod-like liquid crystal molecules in the central part are vertically aligned and ones near the substrates of the cell are horizontally aligned.

Accordingly, the molecules in the central part can be compensated with discotic liquid crystal molecules oriented in homeotropic alignment (in which the discotic planes are horizontally aligned), while those near the substrates can be compensated with discotic liquid crystal molecules oriented in hybrid alignment (in which the long axis of each molecule varies according to the distance between the molecule and the polarizing membrane).

Otherwise, the molecules in the central part can be also compensated with rod-like liquid crystal molecules oriented in homogeneous alignment (in which the long axes are horizontally aligned), while those near the substrates can be compensated with discotic liquid crystal molecules oriented in hybrid alignment.

In homeotropic alignment, the long axes of liquid crystal molecules are oriented on average at an angle of more than 95° to the surface of the polarizing membrane.

In homogeneous alignment, the long axes of liquid crystal molecules are oriented on average at an angle of less than 5° to the surface of the polarizing membrane.

In hybrid alignment, the long axes of liquid crystal molecules are oriented on average at an angle of preferably more than 15°, more preferably 15° to 85°, to the surface of the polarizing membrane.

The optically anisotropic layer in which discotic liquid crystal molecules are oriented in homeotropic alignment or in which rod-like ones are oriented in homogeneous alignment preferably has Rth and Re retardation values in the ranges of 40 to 200 nm and 0 to 70 nm, respectively. The Rth and Re retardation values are defined by the following formulas (I) and (II), respectively.
Rth={(nx+ny)/2−nz}×d (I)
Re=(nx−ny)×d (II)
In the formulas, nx is a refractive index along the slow axis in the film plane, ny is a refractive index along the fast axis in the film plane, nz is a refractive index along the depth of film, and d is the thickness of film.

Japanese Patent Provisional Publication Nos. 12(2000)-304931 and 12(2000)-304932 describe the layer in which discotic liquid crystal molecules are oriented in homeotropic (horizontal) alignment and the layer in which rod-like ones are oriented in homogeneous (horizontal) alignment. Japanese Patent Provisional Publication No. 8(1996)-50206 describes the layer in which discotic liquid crystal molecules are oriented in hybrid alignment.

(Liquid Crystal Display of OCB Mode)

A liquid crystal cell of OCB mode is a liquid crystal cell of bend alignment mode in which rod-like liquid crystal molecules in upper part and ones in lower part are essentially reversely (symmetrically) aligned. A liquid crystal display having the liquid crystal cell of bend alignment mode is disclosed in U.S. Pat. Nos. 4,583,825 and 5,410,422. Since rod-like liquid crystal molecules in upper part and ones in lower part are symmetrically aligned, the liquid crystal cell of bend alignment mode has self-optical compensatory function. Therefore, this mode is referred to as OCB (optically compensatory bend) mode.

In the liquid crystal cell of OCB mode displaying a black image, rod-like liquid crystal molecules are oriented in a similar alignment to ones in the cell of TN mode. Namely, rod-like liquid crystal molecules in the central part are vertically aligned and ones near the substrates of the cell are horizontally aligned.

Since the alignment in displaying a black image is similar to the cell of TN mode, a preferred embodiment of OCB mode is almost the same. However, an area where the molecules are vertically aligned in the central part is larger in OCB mode than in TN mode, and accordingly it is necessary to adjust a little the retardation values of the optically anisotropic layer in which discotic liquid crystal molecules are oriented in homeotropic alignment or in which rod-like ones are oriented in homogeneous alignment. In detail, the Rth and Re retardation values of the optically anisotropic layer are preferably in the ranges of 150 to 500 nm and 20 to 70 nm, respectively.

(Liquid Crystal Display of VA Mode)

In a liquid crystal cell of VA mode, rod-like liquid crystal molecules are essentially vertically aligned while voltage is not applied.

The liquid crystal cell of VA mode include some types: (1) a liquid crystal cell of VA mode in a narrow sense (described in Japanese Patent Provisional Publication No. 2(1990)-176625), in which rod-like liquid crystal molecules are essentially vertically aligned while voltage is not applied, and the molecules are essentially horizontally aligned while voltage is applied; (2) a liquid crystal cell of MVA mode (described in SID97, Digest of tech. Papers, 28(1997), 845), in which the VA mode is modified to be multi-domain type so as to enlarge the viewing angle; (3) a liquid crystal cell of n-ASM mode (described in Abstracts of Japanese Forum of Liquid Crystal (written in Japanese), (1998), pp. 58 to 59), in which rod-like liquid crystal molecules are essentially vertically aligned while voltage is not applied, and the molecules are essentially oriented in twisted multi-domain alignment while voltage is applied; and (4) a cell of SURVAIVAL mode (presented in LCD International '98).

In the liquid crystal cell of VA mode displaying a black image, most of the rod-like liquid crystal molecules are vertically aligned. Accordingly, they are preferably compensated with the optically anisotropic layer in which discotic liquid crystal molecules are oriented in homeotropic alignment or in which rod-like ones are oriented in homogeneous alignment. In addition, in order to compensate a viewing angle dependence of the polarizing plate, it is also preferred to provide another optically anisotropic layer in which rod-like liquid crystal molecules are oriented in homogeneous alignment so that the long axes of the molecules are oriented on average at an angle of less than 5° to a transmission axis of the polarizing membrane.

The optically anisotropic layer in which discotic liquid crystal molecules are oriented in homeotropic alignment or in which rod-like ones are oriented in homogeneous alignment preferably has Rth and Re retardation values in the ranges of 150 to 500 nm and 20 to 70 nm, respectively.

(Liquid Crystal Displays of Other Modes)

The liquid crystal displays of ECB and STN modes can be also optically compensated in the same manner as described above.

(Formation of Optically Anisotropic Layer)

The optically anisotropic layer (if it consists of two or more sub-layers, the first sub-layer placed the nearest to the polarizing membrane) is formed from liquid crystal molecules, and provided on the polarizing membrane directly or otherwise an orientation layer may be provided between them. The orientation layer has a thickness of 10 μm or less.

The liquid crystal compound used in the optically anisotropic layer may be either rod-like or discotic one. The compound may be a polymer liquid crystal or a monomer liquid crystal of low molecular weight. Further, a polymer in which liquid crystal molecules of low molecular weight are cross-linked and hence which no longer behaves as liquid crystal is also usable.

For preparing the optically anisotropic layer, a coating solution containing a liquid crystal compound and other optional components such as polymerization initiator is applied on the membrane or on the orientation layer.

A solvent for the preparation of the coating solution preferably is an organic solvent. Examples of the organic solvents include amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane), esters (e.g., methyl acetate, butyl acetate), ketones (e.g., acetone, methyl ethyl ketone) and ethers (e.g., tetrahydrofuran, 1,2-dimethoxyethane). Alkyl halides and ketones are preferred. Two or more organic solvents can be used in combination.

The solution can be coated according to a conventional coating method (such as a wire-bar coating method, an extrusion coating method, a direct gravure coating method, a reverse gravure coating method or a die coating method).

The thickness of the optically anisotropic layer is preferably in the range of 0.1 to 20 μm, more preferably in the range of 0.5 to 15 μm, most preferably in the range of 1 to 10 μm.

(Rod-Like Liquid Crystal Compound)

Examples of the rod-like liquid crystal compound include azomethines, azoxys, cyanobiphenyls, cyanophenyl esters, benzoic esters, phenyl esters of cyclohexanecarboxylates, cyanophenylcyclohexanes, cyano-substituted phenylpyrimidines, alkoxy-substituted phenylpyrimidines, phenyldioxanes, tolanes, and alkenylcyclohexylbenzonitriles.

Metal complexes are also included in the rod-like liquid crystal compounds. Further, a liquid crystal polymer in which the repeating unit comprises a rod-like liquid crystal moiety is also usable as the rod-like liquid crystal compound. In other words, the rod-like liquid crystal compound may be combined with a (liquid crystal) polymer.

Descriptions of the rod-like liquid crystal compounds are found in “Kagaku-Sosetsu, Ekisho no Kageku” (written in Japanese), vol. 22(1994), Chapters 4, 7 and 11; and “Ekisho Devise Handbook” (written in Japanese), Chapter 3.

The rod-like liquid crystal molecule preferably has a birefringencial index of 0.001 to 0.7.

The rod-like liquid crystal molecule preferably has a polymerizable group to fix the alignment.

The polymerizable group preferably is an unsaturated polymerizable group or an epoxy group, more preferably is an unsaturated polymerizable group, and most preferably is an ethylenically unsaturated group.

(Discotic Liquid Crystal Compound)

Examples of the discotic liquid crystal compound include benzene derivatives described in C. Destrade et al., Mol. Cryst. vol. 71, pp. 111, (1981); truxene derivatives described in C. Destrade et al., Mol Cryst. vol. 122, pp. 141. (1985), Physics lett. A, vol. 78, pp. 82, (1990); cyclohexane derivatives described in B. Kohn et al., Angew. Chem. vol. 96, pp. 70, (1984); and macrocyclic compounds of azacrown-type or phenylacetylene-type described in J. M. Lehn et al., J. Chem. Commun. pp. 1794, (1985), and J. Zhang et al., J. Am. Chem. Soc. vol. 116, pp. 2655, (1994).

The discotic liquid crystal compound may have a structure in which a parent core is located at the center and straight chain groups such as alkyl, alkoxy and substituted benzoyl are radially substituted around the parent core. The compound preferably has such a rotationally symmetrical molecule or aggregate thereof that it can have orientation property. Even if the optically anisotropic layer is formed from discotic liquid crystal molecules, the resultant layer does not always need to contain the discotic liquid crystal molecules. For example, in forming the layer, a low molecular-weight discotic liquid crystal compound having a thermo- or photo-reactive group is polymerized by heat or light to form a polymer that does not behave as liquid crystal. Such polymer can be also used in the invention. Preferred examples of the discotic liquid crystal compound are described in Japanese Patent Provisional Publication No. 8(1996)-50206. Japanese Patent Provisional Publication No. 8(1996)-27284 describes polymerization of the discotic liquid crystal compound.

A polymerizable group should be bound to a discotic core of the discotic compound to cause the polymerization reaction of the compound. However, if the polymerizable group is directly bound to the discotic core, it is difficult to keep the alignment at the polymerization reaction. Therefore, a linking group is introduced between the discotic core and the polymerizable group. Accordingly, the discotic compound having a polymerizable group preferably is a compound represented by the following formula (III):
D(-L-Q)ₙ (III)
in which D is a discotic core; L is a divalent linking group; Q is a polymerizable group; and n is an integer of 4 to 12.

Examples of the discotic cores (D) are shown below. In the examples, LQ (or QL) means the combination of the divalent linking group (L) and the polymerizable group (Q).

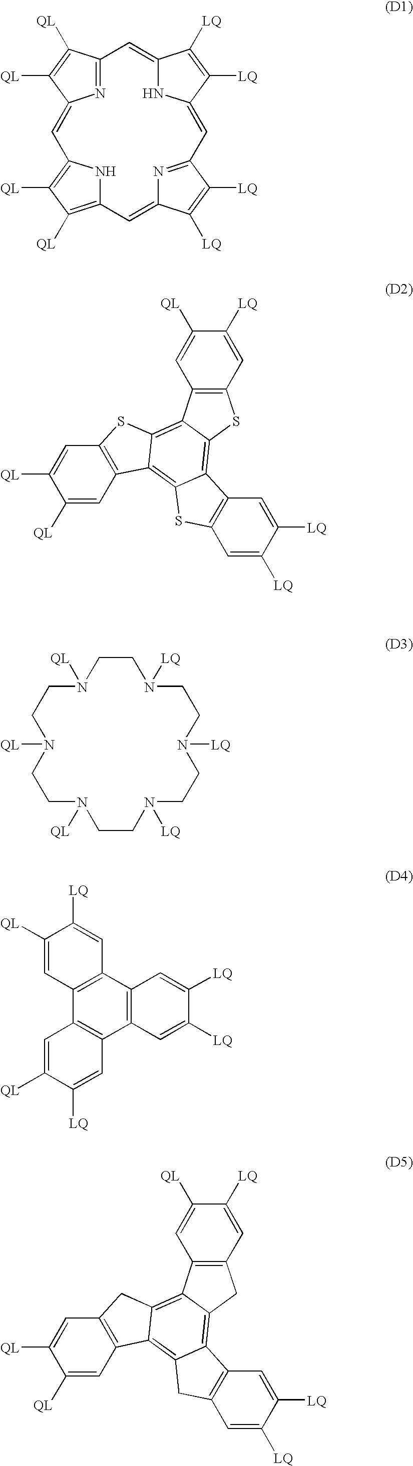

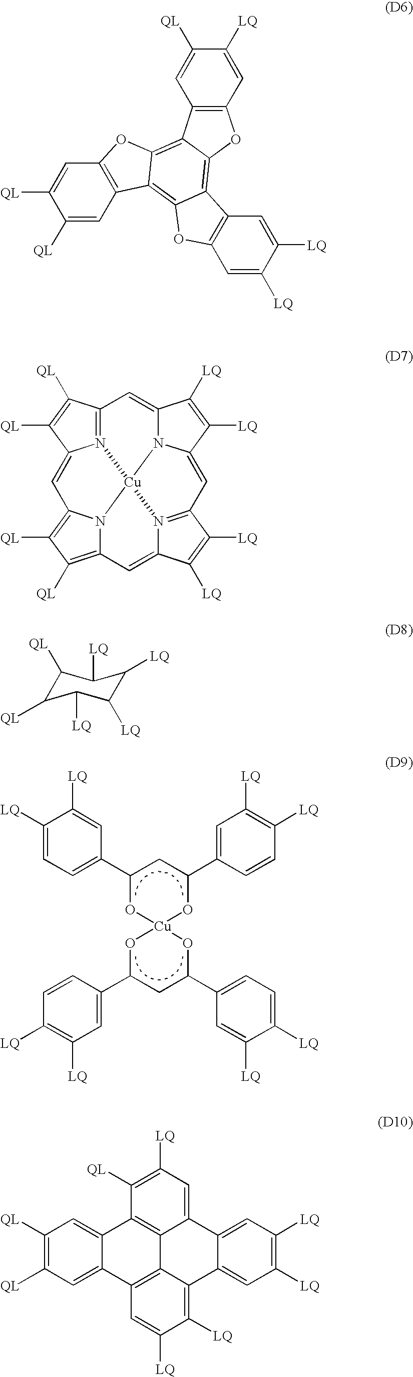

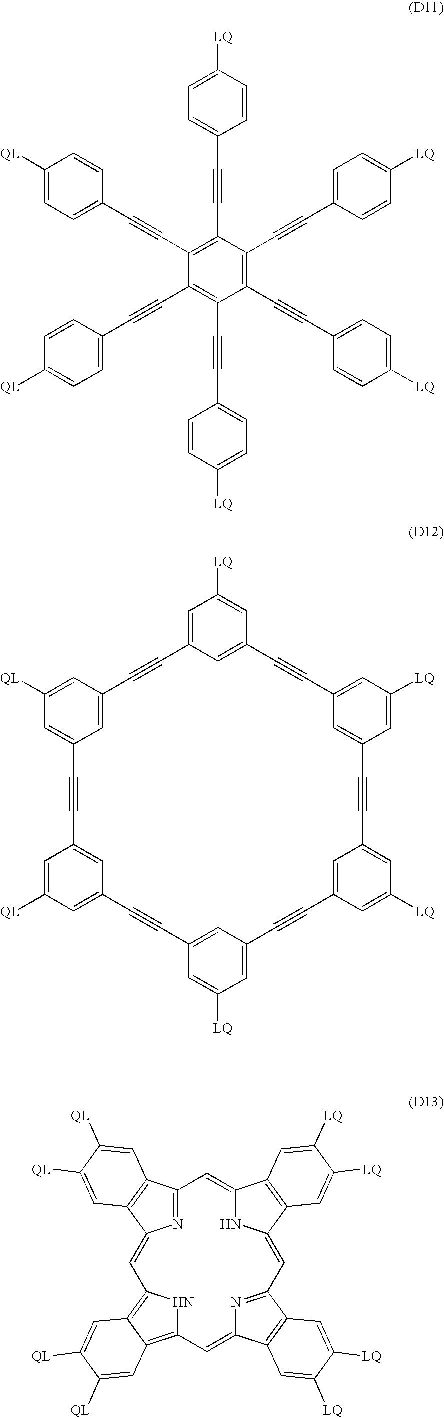

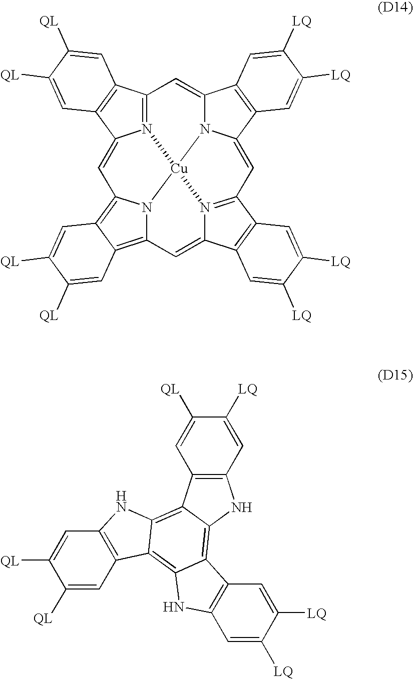

In the formula (III), the divalent linking group (L) preferably is selected from the group consisting of an alkylene group, an alkenylene group, an arylene group, —CO, —NH—, —O—, —S— and combinations thereof. L more preferably is a divalent linking group comprising at least two divalent groups selected from the group consisting of an alkylene group, an arylene group, —CO—, —NH—, —O— and —S—. L more preferably is a divalent linking group comprising at least two divalent groups selected from the group consisting of an alkylene group, an arylene group, —CO— and —O—. The alkylene group preferably has 1 to 12 carbon atoms. The alkenylene group preferably has 2 to 12 carbon atoms. The arylene group preferably has 6 to 10 carbon atoms.

Examples of the divalent linking groups (L) are shown below. In the examples, the left side is attached to the discotic core (D), and the right side is attached to the polymerizable group (Q). The AL means an alkylene group or an alkenylene group. The AR means an arylene group. The alkylene group, the alkenylene group and the arylene group may have a substituent group (e.g., an alkyl group).

L1: -AL-CO—O-AL-

L2: -AL-CO—O-AL-O—

L3: -AL-CO—O-AL-O-AL-

L4: -AL-CO—O-AL-O—CO—

L5: —CO-AR—O-AL-

L6: —CO-AR—O-AL-O—

L7: —CO-AR—O-AL-O—CO—

L8: —CO—NH-AL-

L9: —NH-AL-O—

L10: —NH-AL-O—CO—

L11: —O-AL-

L12: —O-AL-O—

L13: —O-AL-O—CO—

L14: —O-AL-O—CO—NH-AL-

L15: —O-AL-S-AL-

L16: —O—CO-AR—O-AL-CO—

L17: —O—CO-AR—O-AL-O—CO—

L18: —O—CO-AR—O-AL-O-AL-O—CO—

L19: —O—CO-AR—O-AL-O-AL-O-AL-O—CO—

L20: —S-AL-

L21: —S-AL-O—

L22: —S-AL-O—CO—

L23: —S-AL-S-AL-

L24: —S-AR-AL-

The polymerizable group (Q) in the formula (III) is determined according to the polymerization reaction. The polymerizable group (Q) preferably is an unsaturated polymerizable group or an epoxy group, more preferably is an unsaturated polymerizable group, and most preferably is an ethylenically unsaturated group.

In the formula (III), n is an integer of 4 to 12, which is determined according to the chemical structure of the discotic core (D). The 4 to 12 combinations of L and Q can be different from each other. However, the combinations are preferably identical.

If the discotic liquid crystal molecules are oriented in hybrid alignment, the long axes (discotic planes) of molecules are inclined from a plane of the polarizing membrane at angles varying in (along) the direction of depth of the optically anisotropic layer. The angle of each discotic plane generally increases or decreases with increase of distance in the direction of depth from the surface of the polarizing membrane. The angle preferably decreases with increase of the distance. Further, examples of variation of the inclined angle include continuous increase, continuous decrease, intermittent increase, intermittent decrease, variation containing continuous increase and decrease, and intermittent variation containing increase or decrease. The intermittent variation contains an area where the angle does not vary in the course of the thickness direction of the layer. The angle preferably totally increases or decreases in the layer, even if it does not vary in the course. The angle more preferably increases or decreases totally, and it is particularly preferred to vary continuously.

The average direction in which discotic liquid crystal molecules on the polarizing membrane side are oriented on average can be generally controlled by selecting the discotic liquid crystal compound or materials of the orientation layer, or by selecting methods of the rubbing treatment. On the other hand, the average direction on the surface (air) side can be also generally controlled by selecting the discotic liquid crystal compound or additives used together with the liquid crystal compound. Examples of the additives include plasticizer, surface-active agent, polymerizable monomer and polymer. Further, how much the orientation direction of the long axes varies can be also controlled by the above selection.

The plasticizer, the surface-active agent and the polymerizable monomer used together with the liquid crystal compound are preferably compatible with the discotic liquid crystal compound, and they preferably give variation of the inclined angle or do not inhibit the discotic liquid crystal molecules from aligning. Polymerizable monomers (e.g., compounds having a vinyl, vinyloxy, acryloyl or methacryloyl group) are preferred. Those compounds are added generally in an amount of 1 to 50 wt. %, preferably in an amount of 5 to 30 wt. % based on the amount of the discotic liquid crystal compound. If a monomer having 4 or more polymerizable functional groups is mixed to use, the adhesion between the orientation layer and the optically anisotropic layer is enhanced.

The polymer used together with the discotic liquid crystal compound is preferably compatible with the discotic liquid crystal compound, and preferably gives variation of the inclined angle.

The polymer is, for example, cellulose ester. Preferred examples of the cellulose ester include cellulose acetate, cellulose acetatepropionate, hydroxypropyl cellulose, and cellulose acetatebutylate. In order not to prevent the discotic liquid crystal molecules from aligning, the amount of the polymer is generally in the range of 0.1 to 10 wt. %, preferably in the range of 0.1 to 8 wt. %, more preferably in the range of 0.1 to 5 wt. % based on the amount of the discotic liquid crystal compound.

The transition temperature from discotic nematic phase to solid phase of the discotic liquid crystal compound is preferably in the range of 70 to 300° C., more preferably 70 to 170° C.

(Fixation of Alignment of Liquid Crystal Molecules)

The aligned discotic liquid crystal molecules can be fixed with the alignment maintained. The discotic liquid crystal molecules are fixed preferably by a polymerization reaction. The polymerization reaction can be classified into a thermal reaction with a thermal polymerization initiator and a photoreaction with a photo polymerization initiator. A photo polymerization reaction is preferred.

Examples of the photo polymerization initiators include α-carbonyl compounds (described in U.S. Pat. Nos. 2,367,661, 2,367,670), acyloin ethers (described in U.S. Pat. No. 2,448,828), α-hydrocarbon substituted aromatic acyloin compounds (described in U.S. Pat. No. 2,722,512), polycyclic quinone compounds (described in U.S. Pat. Nos. 2,951,758, 3,046,127), combinations of triarylimidazoles and p-aminophenyl ketones (described in U.S. Pat. No. 3,549,367), acridine or phenazine compounds (described in Japanese Patent Provisional Publication No. 60(1985)-105667 and U.S. Pat. No. 4,239,850) and oxadiazole compounds (described in U.S. Pat. No. 4,212,970).

The amount of the photo polymerization initiator is preferably in the range of 0.01 to 20 wt. %, and more preferably in the range of 0.5 to 5 wt. % based on the solid content of the coating solution.

The light irradiation for the photo polymerization is preferably conducted with ultraviolet rays.

The exposure energy is preferably in the range of 20 to 50,000 mJ/cm², more preferably in the range of 20 to 5,000 mJ/cm², most preferably in the range of 100 to 800 mJ/cm². The light irradiation can be conducted while the layer is heated to accelerate the photo polymerization reaction. The protective layer may be provided on the optically anisotropic layer.

(Polarizing Membrane)

The polarizing membrane is preferably a membrane of coating type represented by Optiva Inc. or a film comprising a binder and either iodine or a dichromatic dye.

Iodine or the dichromatic dye in the polarizing membrane causes polarizing functions when the molecules thereof are oriented. They are preferably oriented along, the binder molecules, or otherwise the molecules of dichromatic dye preferably automatically organize to be oriented in a certain direction like liquid crystal molecules do.

A commercially available polarizing membrane is generally produced by immersing a stretched polymer film in a bath of iodine or dichromatic dye solution so that the iodine or dichromatic dye may penetrate into the binder.

In a commercially available polarizing membrane, the iodine or dichromatic dye is distributed in an area within the depth of approx. 4 μm from each of the top and bottom surfaces (the total thickness of the area is approx. 8 μm). However, in order to obtain sufficient polarizability, the area where the iodine or dichromatic dye is distributed is required to have at least 10 μm thickness in total. How deeply the iodine or dichromatic dye penetrates can be controlled by adjusting the concentration of iodine or dichromatic dye solution, the temperature of bath and/or the time for immersing.

As described above, the thickness of binder is at least 10 μm. In consideration of preventing the display from leaking light, the membrane is preferably as thin as possible. It is preferably thinner than a commercially available polarizing membrane (having approx. 30 μm). The thickness is more preferably 25 μm or less, further preferably 20 μm or less. The polarizing membrane having a thickness of 20 μm or less prevents a large liquid crystal display of 17 inches from leaking light.

The binder of the polarizing membrane may be cross-linked.

A polymer cross-linkable by itself can be used as the binder. Further, a polymer which originally has functional groups or to which functional groups are introduced can be reacted with light, heat or pH variation to form the polarizing membrane.

Otherwise, the polymer may be cross-linked with a cross-linking agent. In detail, bonding groups given by the reactive cross-linking agent can be introduced to cross-link the binder of the polarizing membrane.

In a normal process, a coating solution containing the polymer and, if needed, the cross-linking agent is applied onto a transparent support, and then heated to induce the cross-linking reaction. The reaction may be caused at any stage from the first step of applying the coating solution to the final step of producing the resultant membrane, so long as the resultant membrane has sufficient durability.

Polymers cross-linkable either by itself or with cross-linking agents can be used. Examples of the polymers include polymethyl methacrylate, polyacrylic acid, polymethacrylic acid, polystyrene, polyvinyl alcohol and denatured polyvinyl alcohol, poly(N-methylolacrylamide), polyvinyl toluene, chlorinated polyolefin (polyvinyl chloride), polyester, polyimide, polyvinyl acetate, polyethylene, carboxymethyl cellulose, polypropylene, polycarbonate, and copolymers thereof (e.g., acrylic acid/methacrylic acid copolymer, styrene/maleinimide copolymer, styrene/vinyltoluene copolymer, vinyl acetate/vinyl chloride copolymer, ethylene/vinyl acetate copolymer). Silane-coupling agents are also usable as the polymer. Preferred examples are water-soluble polymers (e.g., poly(N-methylolacrylamide), carboxymethylcellulose, gelatin, polyvinyl alcohol and denatured polyvinyl alcohol). Gelatin, polyvinyl alcohol and denatured polyvinyl alcohol are particularly preferred, and polyvinyl alcohol and denatured polyvinyl alcohol are most preferred.

The saponification degree of the polyvinyl alcohol or denatured polyvinyl alcohol is in the range of 70 to 100%, preferably in the range of 80 to 100%, more preferably in the range of 95 to 100%. The polymerization degree of the polyvinyl alcohol is preferably in the range of 100 to 5,000.

Examples of the denatured polyvinyl alcohol include polyvinyl alcohols denatured by copolymerization, by chain transfer and by block polymerization. Examples of the denaturing group in the copolymerization include COONa, Si(OH)₃, N(CH₃)₃.Cl, C₉H₁₉COO, SO₃Na and C₁₂H₂₅. Examples of the denaturing group in the chain transfer include COONa, SH and C₁₂H₂₅. The polymerization degree of the denatured polyvinyl alcohol is preferably in the range of 100 to 3,000. The denatured polyvinyl alcohol is described in Japanese Patent provisional Publication Nos. 8(1996)-338913, 9(1997)-152509 and 9(1997)-316127.

Non-denatured or alkylthio-denatured polyvinyl alcohols having saponification degrees of 85 to 95% are particularly preferred.

Two or more non-denatured and denatured polyvinyl alcohols may be used in combination.

The more the cross-linking agent is added to the binder, the more the durability of polarizing membrane against moisture and heat is improved. However, if the amount of cross-linking agent is 50 wt. % or more based on the amount of the binder, the molecules of iodine or dichromatic dye are poorly aligned. Accordingly, the amount of cross-linking agent is preferably in the range of 0.1 to 20 wt. %, more preferably in the range of 0.5 to 15 wt. % based on the amount of the binder.

Even after the cross-linking reaction is completed, the binder contains non-reacted cross-linking agent a little. The amount of the non-reacted cross-linking agent remaining in the binder is preferably not more than 1.0 wt. %, more preferably not more than 0.5 wt. % based on the amount of the binder. If the binder contains the non-reacted agent in an amount of more than 1.0 wt. %, the membrane often has poor durability. If the polarizing membrane containing a considerable amount of remaining cross-linking agent is installed in a liquid crystal display and used for a long time or left under hot and humid condition, the polarizability is often lowered.

The cross-linking agent is described in U.S. Republished Pat. No. 23,297. Boron compounds (e.g., boric acid, borax) are also usable as the cross-linking agent.

Examples of the dichromatic dye include azo dyes, stilbene dyes, pyrazolone dyes, triphenyl methane dyes, quinoline dyes, oxazine dyes, thiazine dyes, and anthraquinone dyes. Water-soluble dyes are preferred. The dichromatic dye preferably has a hydrophilic group (e.g., sulfo, amino, hydroxyl).

Examples of the dichromatic dye further include C.I. direct yellow 12, C.I. direct orange 39, C.I. direct orange 72, C.I. direct red 39, C.I. direct red 79, C.I. direct red 81, C.I. direct red 83, C.I. direct red 89, C.I. direct violet 48, C.I. direct blue 67, C.I. direct blue 90, C.I. direct green 59 and C.I. direct acid red 37. Japanese Patent Provisional Publication Nos. 1(1989)-161202, 1(1989)-172906, 1(1989)-172907, 1(1989)-183602, 1(1989)-248105, 1(1989)-265205 and 7(1995)-261024 describe the dichromatic dye. The dichromatic dye is used in the form of a free acid or a salt (alkali metal salt, ammonium salt, amine salt). Two or more dichromatic dyes may be used in combination, to produce polarizing membranes having various hues. The dichromatic dye enables a polarizing membrane to show a desired hue. For example, a dichromatic dye or a mixture of various dichromatic dyes showing black hue when polarizing axes are perpendicularly crossed is preferred. The polarizing membrane or plate comprising such dichromatic dye or mixture is excellent in both polarizability and transmittance when singly used.

Both transmittance and polarizability of the polarizing plate are preferably as high as possible, so as to increase the contrast ratio of liquid crystal display. The transmittance at 550 nm is preferably in the range of 30 to 50%, more preferably in the range of 35 to 50%, most preferably in the range of 40 to 50%. The polarizability at 550 nm is preferably in the range of 90, to 100%, more preferably in the range of 95 to 100%, most preferably in the range of 99 to 100%.

The polarizing membrane and the optically anisotropic layer, or otherwise the polarizing membrane and the orientation layer can be laminated with adhesive. Examples of the adhesive include polyvinyl alcohol resins (e.g., polyvinyl alcohols denatured with acetoacetyl group, sufonic group, carboxyl group or oxyalkylene group) and aqueous solutions of boron compounds. Polyvinyl alcohol resins are preferred. A layer of the adhesive has a dry thickness of preferably 0.01 to 10 μm, more preferably 0.05 to 5 μm.

(Production of Polarizing Plate)

In consideration of production yield of the polarizing membrane, the binder is preferably stretched in a direction inclined at 10 to 800 to the longitudinal (MD) direction of the membrane. Otherwise, the binder is preferably dyed with iodine or dichromatic dye after subjected to rubbing treatment. The angle of the inclined direction for stretching (inclined angle) is preferably corresponding to the angle between the longitudinal or lateral direction of liquid crystal cell and the transmission axes of polarizing plates laminated on both sides of the cell in the liquid crystal display (LCD).

The inclined angle is normally 45°, but is not always 45° in a recently developed LCD of transmission type, reflection type or semi-transmission type. The stretching direction is, hence, preferably adjusted according to the LCD.

In stretching the binder, the stretching ratio is preferably in the range of 2.5 to 30.0, more preferably in the range of 3.0 to 10.0. The stretching can be carried out either in air (dry stretching) or in water (wet stretching). The stretching ratio in dry stretching is preferably in the range of 2.5 to 5.0 while that in wet stretching is preferably in the range of 3.0 to 10.0. The stretching including oblique stretching may be carried out several times, and if so the binder can be evenly stretched even in a high stretching ratio. Before the oblique stretching, the binder may be beforehand laterally or longitudinally stretched (so slightly that the lateral shrinkage may be prevented).

The binder can be biaxially stretched. In the biaxial stretching, the binder is stretched rightward and leftward in different steps. The biaxial stretching can be carried out in the normal manner conventionally adopted in forming a known film. The rightward and leftward stretching speeds in the biaxial stretching are different from each other, and accordingly before the stretching it is necessary to form the binder film so that the thickness at the right side of the film and that at the left side are different from each other. For example, in forming the film by casting a binder solution, a die equipped with a taper can be used so that the amount of the solution cast on the right side and that on the left side may be different from each other.

Thus, a binder film stretched obliquely at 10° to 80° to the MD direction of the polarizing membrane can be produced.

The rubbing treatment can be conducted in the manner adopted widely in aligning liquid crystal molecules of LCD. The surface of the film is rubbed with paper, cloth (gauze, felt, nylon, polyester) or rubber along a certain direction, to give the aligning function. Generally, the film is rubbed several times with cloth on which fibers having the same length and thickness are provided. It is preferred to use a rubbing roll whose out of roundness, out of cylindricalness and eccentricity are all 30 μm or less. The lapping angle of the film onto the rubbing roll is preferably in the range of 0.1 to 90°. As described in Japanese Patent Provisional Publication No. 8(1996)-160430, the lapping angle may be 360° or more (namely, the film may be wound around the roll) to perform the rubbing treatment stably.

In the case where the binder in the form of a long film is subjected to the rubbing treatment, the film is preferably transferred with a constant tension at a speed of 1 to 100 m/minute. The rubbing roll preferably rotates parallel to the transferring direction so freely that the rubbing angle can be desirably set up. The rubbing angle is preferably in the range of 0° to 60°. For the liquid crystal display, the rubbing angle is preferably in the range of 40° to 50°, particularly 45°.

On the other surface of polarizing membrane (the surface opposite to the optically anisotropic layer), a polymer film is preferably provided to form a layered structure of anisotropic layer/membrane/polymer film.

(Polymer Film)

The polymer film preferably has a light-transmittance of 80% or more. Examples of the polymer include cellulose esters (e.g., cellulose acetate, cellulose diacetate), norbornene-based polymers and polymethacrylic esters. Commercially available polymers such as Artone (norbornene-based polymer) may be used.

Cellulose esters are preferred, and cellulose esters of lower fatty acids are more preferred. The term “lower fatty acids” means fatty acids having 6 or less carbon atoms. The number of carbon atoms is preferably 2 (cellulose acetate), 3 (cellulose propionate) or 4 (cellulose butyrate). Cellulose acetate is particularly preferred. Cellulose esters of mixed fatty acids such as cellulose acetatepropionate and cellulose acetatebutyrate are also usable.

In addition, polymers that originally show birefringence when external force is applied (e.g., polycarbonate, polysulfone) can be also used if they are modified so as not to show the birefringence (in the manner described in WO00/26705).

For the polymer film, cellulose acetate having an acetic acid content of 55.0 to 62.5% is preferably used. The acetic acid content is more preferably in the range of 57.0 to 62.0%.

The term “acetic acid content” means the amount of combined acetic acid per one unit weight of cellulose. The acetic acid content is determined according to ASTM: D-817-91 (tests of cellulose acetate).

The cellulose acetate has a viscosity average polymerization degree (DP) of preferably 250 or more, more preferably 290 or more. Further, it is also preferred for the cellulose acetate to have a narrow molecular weight distribution of Mw/Mn (Mw and Mn are weight and number average molecular weights, respectively) determined by gel permeation chromatography. The value of Mw/Mn is preferably in the range of 1.0 to 1.7, more preferably in the range of 1.00 to 1.65, most preferably in the range of 1.0 to 1.6.

In a cellulose acetate, hydroxyl groups at 2-, 3- and 6-position are not equally substituted (namely, the substitution degree at each position is not equal to one third of the total substitution degree), and the substitution degree at 6-position is apt to be relatively small. In the cellulose acetate used as the polymer film in the invention, the substitution degree at 6-position is preferably not smaller than those at 2- and 3-positions.

The substitution degree at 6-position is preferably 30% to 40%, more preferably 31% to 40%, most preferably 32% to 40%, based on the total substitution degree. Further, the substitution degree at 6-position is preferably 0.88 or more.

The substitution degree at each position can be measured by means of NMR. A cellulose acetate having a high substitution degree at 6-position can be prepared according to the methods described in Japanese Patent Provisional Publication No. 11(1999)-5851.

The polymer film preferably reduces the dimension change of the polarizing membrane. For the purpose of that, the product of thickness and (volumetric) elasticity is preferably controlled. It is possible to reduce the dimension change by thickening the film. However, since a LCD has been getting thinner and thinner recently, the elasticity is preferably increased while the thickness is not changed.

The elasticity is evaluated as a modulus of elasticity determined by means of a fine surface hardness meter (Fischer Scope H100VP-HCU, Fischer Instruments Co., Ltd.). In detail, a pyramidal pusher made of diamond (angle of tip: 136°) is pressed onto the film with a testing weight. The depth in which the pusher sinks is then measured, and a universal hardness is calculated on the basis of the testing weight and the surface area of the pressed mark, to determine the modulus of elasticity. The depth is 1 μm. The modulus of surface elasticity correlates with that of bulk elasticity, and hence is directly regarded as the modulus of bulk elasticity.

Fine particles of metal oxide are preferably added so that the modulus of elasticity of the polymer film may be 40 Gpa or more.

The fine particles of metal oxide preferably have Mohs hardness of 7 or more. Examples of the metal oxide include silicon dioxide, titanium dioxide, zirconium oxide and aluminum oxide. The metal oxide preferably has a refractive index similar to that of the polymer film. If the polymer film is made of cellulose acetate, silicon dioxide (silica) and aluminum oxide (alumina) are preferred in consideration of the refractive index.

The mean size of fine particles is preferably in the range of 1 to 400 nm, more preferably in the range of 5 to 200 nm, most preferably in the range of 10 to 100 nm. If it is less than 1 nm, the particles are liable to aggregate and accordingly the transparency of the film is often impaired. On the other hand, if it is more than 400 nm, the haze of the film increases and hence the transparency is also lowered.

The amount of fine particles is preferably in the range of 1 to 99 vol. %, more preferably in the range of 5 to 80 vol. %, further preferably in the range of 5 to 50 vol. %, most preferably in the range of 5 to 20 vol. %, based on the volume of the polymer.

The fine particles of metal oxide generally have hydrophilic surfaces, and hence have low affinity with cellulose acetate. In fact, if simply the metal oxide particles and cellulose acetate are mixed to use, the resultant film is fragile and has poor scratching resistance. Accordingly, in order to improve the affinity between the fine particles and cellulose acetate, the fine particles are preferably subjected to surface-treatment with a surface-modifying agent.

The surface-modifying agent preferably comprises a segment having a functional group connecting to the metal oxide (inorganic fine particles) and an organic segment having high affinity with cellulose acetate. Examples of the functional group include metal (e.g., silicon, aluminum, titanium, zirconium)-alkoxide groups, inorganic acidic ester groups (e.g., phosphoric monoester, phosphoric diester, sulfuric monoester), acidic groups (e.g., phosphoric group, sulfonic group, carboxylic group), salts or acid chlorides thereof, amino group and amide group.

The organic segment preferably has a structure having high affinity with cellulose acetate. In the structure, a polar group (e.g., ester bonding, epoxy group, ether bonding) is preferably included.

As the surface-modifying agent, a metal alkoxide compound or a compound having both anionic group and ester, epoxy or ether group is preferably used.

Examples of the surface-modifying agent include silane-coupling agents [e.g., H₂C═C(CH₃)COOC₃H₆Si(OCH₃)₃, H₂C═CH—COOC₃H₆Si(OCH₃)₃, glycidyl-CH₂OC₃H₆Si(OCH₃)₃, ClCH₂CH₂—CH₂OC₃H₆Si(OCH₃)₃, R(OCH₂CH₂)ₙOC₃H₆Si(OCH₃)₃, R(OCH₂CH(CH₃))ₙOC₃H₆Si(OCH₃)₃, ROCO(CH₂)ₙSi(OCH₃)₃CH₃COCH₂—COOC₃H₆Si(OCH₃)₃, (CH₃CH₂O)₃POC₃H₆Si(OCH₂CH₃)₃], titanate coupling agents [e.g., C₁₇H₃₄COOTi(OCH(CH₃)₂)₃], aluminum coupling agents, saturated carboxylic acids [e.g., CH₃COOH, C₂H₅COOH, CₙH₂ₙ₊₁COOH], unsaturated carboxylic acids [e.g., oleic acid], hydroxycarboxylic acids [e.g., citric acid, tartaric acid], dibasic acids [e.g., oxalic acid, malonic acid, succinic acid], aromatic carboxylic acids [e.g., benzoic acid], terminal carboxylic esters [e.g., RCOO(C₅H₁₀COO)ₙH, H₂C═CHCOO(C₅H₁₀COO)ₙH], phosphoric monoesters [e.g., H₂C═C(CH₃)COOC₂H₄OCOC₅H₁₀OPO(OH)₂], phosphoric diesters [e.g., (H₂C═C(CH₃)COOC₂H₄OCOC₅H₁₀O)₂POOH], phosphonic acid-containing organic compounds [e.g., phenylphosphonic acid], sulfuric monoesters [e.g., H₂C═C(CH₃)COOC₂H₄OSO₃H], sulfonic group-containing organic compounds [e.g., benzenesolfonic acid], and polyoxyethylene derivatives [e.g., polyoxyethylene aryl ether, polyoxyethylene alkyl ether, polyoxyethylene aryl ester, polyoxyethylene alkyl ester]. In the above, n is an integer of 1 to 10 (preferably 1 to 5, 1 to 3). R in the above represents an alkyl group having 1 to 4 carbon atoms (i.e., methyl, ethyl, propyl or butyl).

Commercially available titanate coupling agents [e.g., Plane-act KRTTS, KR46B, KR55, KR41B, KR38S, KR138S, KR238S, 338X, KR44, KR9SA (Ajinomoto Co., Inc.)] and commercially available aluminum coupling agents [e.g., Plane-act AL-M (Ajinomoto Co., Inc.)] are also usable.

The surface-modifying treatment of fine particles is preferably conducted in a solution. In detail, the fine particles may added in a solution containing the surface-modifying agent, and then stirred and dispersed by means of a ultrasonic disperser, a stirrer, a homogenizer, a dissolver, a planetary mixer, a paint shaker, a sand-grinder or a kneader.

The solvent for preparing the solution of surface-modifying agent is preferably an organic solvent having large polarity. Alcohols, ketones and esters are preferred. If the polymer is cellulose acetate, the solvent is preferably the same as that of the dope.

The fine particles of metal oxide can be added, mixed and stirred in the dope of cellulose acetate. Before added in the dope, the fine particles are particularly preferably subjected to the surface treatment and dispersed. In addition, after added in the dope, they are preferably further dispersed to mix evenly by means of dispersing machine (e.g., dissolver, planetary mixer, sand-grinder, kneader, roll mill).

(Light-Diffusing Layer)

A light-diffusing layer is preferably provided on the polarizing plate, to further enlarge the viewing angle of liquid crystal display.

The polarizing plate provided with the light-diffusing layer can keep the quality of displayed image high (keep the displayed image from blurring) and improve the viewing angle. Light emitted from a backlight of the display is scattered by the diffusing film provided on the observer-side surface of the plate. The more the diffusing film scatters the light, the more the viewing angle is improved. However, if the light is too much scattered, the amount of light scattered backward is so increased that the brightness of image seen frontally is lowered. Further, the sharpness of displayed image is often impaired. A conventional light-diffusing layer has been provided on the observer-side surface of the polarizing plate, and it has been impossible to improve both the blur of image and the viewing angle. However, if the light-diffusing layer is placed nearer to the liquid crystal cell, the blur of image is reduced. The haze of the light-diffusing layer is preferably in the range of 30% to 95%, more preferably in the range of 35% to 70%.

In order to increase the haze of internal scattering, transparent fine particles may be thickly contained in the layer, or otherwise the layer may be thickened. Further, the transparent fine particles and a binder of the layer may be selected so that their refractive indexes are very different from each other.

If the fine particles have small sizes, they scatter light well but the probability of scattering is lowered. The sizes are preferably in the range of 0.5 to 2.0 μm. The refractive index of fine particles is preferably smaller than that of the binder.

The binder of light-diffusing layer preferably has a refractive index of 1.51 to 2.00. The refractive index of fine particles is preferably in the range of 1.40 to 1.68. Cellulose acetate, which is preferably used as the polymer film, has the refractive index of 1.48.

The refractive index of the binder is preferably high enough to increase the scattering efficiency. Examples of the binder having a high refractive index include a resin formed from DPHA monomers dispersing zirconia (average refractive index: 1.62). A low-refractive index layer (refractive index: 1.35 to 1.45) may be provided on the light-diffusing layer, to reduce loss of light caused by reflection.

The fine particles are preferably transparent, and for example, fine particles of polymethylmethacrylate (mean particle size: 1.5 μm, refractive index: 1.51) are particularly preferred. They do not need to be spherical. For example, rod-like or tabular particles having an aspect ratio of 2 to 50 (preferably 5 to 30) can be used. It is preferred that the particles scatter light in the normal direction of the film as little as possible but they scatter light in an oblique direction as efficiently as possible.

The difference between the refractive index of transparent fine particles and that of the whole light-diffusing layer is preferably in the range of 0.02 to 0.15. If it is less than 0.02, the layer scatters light insufficiently. If it is more than 0.15, the layer scatters light so much that the whole film is whitened. The difference of refractive index is more preferably in the range of 0.03 to 0.13, most preferably in the range of 0.04 to 0.10.

The transparent fine particles preferably have sizes of 0.5 to 2.0 μm, so as to obtain an optimum angular distribution of scattering.

For improving the quality of displayed image (for improving the downward viewing angle), it is necessary to diffuse incident light at a certain degree. The more the light is diffused, the more the viewing angle is improved. However, in consideration of the quality of displayed image, it is necessary to ensure the brightness of image seen frontally and hence to improve the transparency as high as possible.

If the particle sizes are 0.5 μm or less, the layer scatters the light so much that the viewing angle is remarkably improved. However, at the same time, the amount of light scattered backward is so increased that the brightness is considerably lowered. On the other hand, if the sizes are 2.0 μm or more, the layer scatters the light so little that the viewing angle is not improved. Accordingly, the sizes of transparent fine particles are preferably in the range of 0.6 to 1.8 μm, more preferably in the range of 0.7 to 1.7 μm.

As the transparent fine particles, inorganic fine particles may be used in place of organic ones such as the aforementioned polymethylmethacrylate fine particles. The size distribution of the particles is preferably monodispersed. The less the sizes vary, the less the scattering characters differ. Accordingly, if so, it is easy to control the haze.

If the transparent fine particles are spherical, plastic beads are preferred. The plastic beads are preferably made of material having high transparency, and the difference between the refractive index of the material and that of the transparent resin (binder) is preferably in the aforementioned range.

Examples of the material for the beads include polymethylmethacrylate (refractive index: 1.51), acryl/styrene copolymer (refractive index: 1.55), melamine (refractive index: 1.57), polycarbonate (refractive index: 1.57), polystyrene (refractive index: 1.60), cross-linked polystyrene (refractive index: 1.61), polyvinyl chloride (refractive index: 1.60), and benzoguanamine/melamine formaldehyde (refractive index: 1.68).

The size of the beads is preferably in the range of 0.5 to 5 μm, as described above. The amount of the beads is preferably in the range of 5 to 30 weight parts based on 100 weight parts of the binder.

Since the transparent fine particles are liable to settle down in the binder, inorganic filler (e.g., silica) may be added. The more the inorganic filler is added, the more the particles are prevented from settling down. However, if it is too much added, the transparency of the film is impaired. Accordingly, the inorganic filler consisting of grains having sizes of 0.5 μm or less are preferably added in an amount of less than 0.1 wt. % based on the amount of the transparent resin. That amount of the filler hardly lowers the transparency.

As the binder, a composition comprising a commercially available polymer or a resin hardened with ultraviolet ray or electron beam is used. An ionization radiation (i.e., ultraviolet ray or electron beam)-setting resin, a mixture of ionization radiation-setting resin and thermoplastic resin in a solvent, or a thermosetting resin can be used.

The thickness of the light-diffusing layer is preferably in the range of 0.5 to 50 μm, more preferably in the range of 1 to 20 μm, further preferably in the range of 2 to 10 μm, most preferably in the range of 3 to 7 μm.

The binder has a refractive index preferably in the range of 1.51 to 2.00, more preferably in the range of 1.53 to 1.95, further preferably in the range of 1.57 to 1.90, most preferably in the range of 1.64 to 1.80. The refractive index of the transparent resin is determined by measuring the layer formed without the transparent fine particles.

If the refractive index is too small, the layer cannot prevent reflection well. On the other hand, if it is too high, the reflected light is unfavorably colored.

The binder is preferably a polymer having a main chain of saturated hydrocarbon or polyether (more preferably, hydrocarbon), and the polymer is preferably cross-linked. The polymer having a main chain of saturated hydrocarbon is preferably prepared from ethylenically unsaturated monomers through polymerization reaction. The monomer preferably has two or more ethylenically unsaturated groups to form a cross-linked polymer.

Examples of the monomer having two or more ethylenically unsaturated polymerizable groups include esters of polyhydric alcohol and (meth)acrylic acid (e.g., ethylene glycol di(meth)acrylate, 1,4-dichlorohexane diacrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,3,5-cyclohexanetriol trimethacrylate, polyurethane polyacrylate, polyester polyacrylate), vinylbenzene derivatives (e.g., 1,4-divinylbenzene, 4-vinylbenzoic acid-2-acryloyl ethylester, 1,4-divinylcyclohexanone), vinylsulfones (e.g., divinylsulfone), acrylamides (e.g., methylene bisacrylamide) and methacrylamide. In consideration of hardness and scratching resistance of the film, (meth)acrylate having three or more functional groups is preferred, and acrylate having five or more functional groups is more preferred. A mixture of dipentaerythritol pentaacrylate and dipentaerythritol hexaacrylate is commercially available and particularly preferably used.

These monomers having ethylenically unsaturated polymerizable groups are dissolved in a solvent together with various polymerization initiators and other additives. The thus-prepared solution (coating solution) is applied on a support, dried and polymerized to harden by ionization radiation or heat.

In place of or in addition to the monomers having two or more ethylenically unsaturated polymerizable groups, cross-linking groups may be introduced into the binder to be cross-linked. Examples of the cross-linking group include isocyanate group, epoxy group, aziridine group, oxazolidine group, aldehyde group, carbonyl group, hydrazine group, carboxyl group, methylol group, and active methylene group. Further, the cross-linked structure can be obtained by the monomers such as vinylsulfonic acid, acid anhydride, cyanoacrylate derivative, melamine, etherized methylol, ester, urethane, and methyl alkoxide (e.g., tetramethoxy-silane). Furthermore, the binder may be cross-linked by decomposition of some monomers such as block isocyanate group. As the cross-linking group, not only groups that immediately induce cross-linking reaction but also groups that are decomposed to cause the reaction can be used.

The binder having the cross-linking group can be cross-linked by heating.

It is preferred to incorporate monomers having high refractive indexes or superfine-particles of metal oxide having a high refractive index into the binder polymer, to form the light-diffusing layer.

Examples of the monomers having high refractive indexes include bis(4-methacryloylthiophenyl)sulfide, vinylnaphthalene, vinylphenylsulfide, and 4-methacryloxyphenyl-4′-methoxyphenylthioether.

The metal oxide having a high refractive index is preferably an oxide of at least one metal selected from the group consisting of zirconium, titanium, aluminum, indium, zinc, tin and antimony. The size of the superfine particles is 100 nm or less, preferably 50 nm or less. Examples of the metal oxide include ZrO₂, TiO₂, Al₂O₃, In₂O₃, ZnO, SnO₂, Sb₂O₃ and ITO. Among then, ZrO₂ is particularly preferred.

The amount of the monomers having high refractive indexes or the superfine particles of metal oxide is in the range of 10 to 90 wt. %, preferably in the range of 20 to 80 wt. % based on the total weight of the transparent resin.

For forming the layer, a solution of the binder is applied on the film. Examples of the solvent include ethers having 3 to 12 carbon atoms (e.g., dibutyl ether, dimethoxy methane, dimethoxy ethane, diethoxy ethane, propylene oxide, 1,4-dioxane, 1,3-dioxolane, 1,3,5-trioxane, tetrahydrofuran, anisole, phenetole), ketones having 3 to 12 carbon atoms (e.g., acetone, methyl ethyl ketone, diethyl ketone, dipropyl ketone, diisobutyl ketone, cyclopentanone, cyclohexanone, methyl cyclohexanone), esters having 3 to 12 carbon atoms (e.g., ethyl formate, propyl formate, n-pentyl formate, methyl acetate, ethyl acetate, methyl propionate, ethyl propionate, n-pentyl acetate, γ-butyrolactone), organic solvents having two or more kinds of functional groups (e.g., methyl 2-methoxyacetate, methyl 2-ethoxyacetate, ethyl 2-ethoxyacetate, ethyl 2-ethoxypropionate, 2-methoxyehanol, 2-propoxyethanol, 2-butoxyethanol, 1,2-diacetoxyacetone, acetylacetone, diacetonealcohol, methyl acetoacetate, ethyl acetoacetate). These may be used singly or in combination.

The aforementioned composition of ionization radiation-setting resin can be hardened by irradiation of electron beams or ultraviolet rays.

For the irradiation of electron beams, various electron accelerators (such as Cockcroft-Walton accelerator, Van de Graaff accelerator, resonant transforming accelerator, insulating core-transforming accelerator, linear accelerator, dinamitron, high-frequency accelerator) can be used. The electron beams have energy preferably in the range of 50 to 1,000 KeV, more preferably in the range of 100 to 300 KeV.

For the irradiation of ultraviolet rays, various light sources (such as extra high pressure mercury lamp, high pressure mercury lamp, low pressure mercury lamp, carbon arc lamp, xenon arc lamp, metal halide arc lamp) can be used.

The light-diffusing layer can be provided on the optically anisotropic layer or between the optically anisotropic layer and the polarizing membrane. The orientation layer placed between the anisotropic layer and the membrane may be made to serve as the light-diffusing layer. The polymer film may be placed between the light-diffusing layer and the anisotropic layer.

(Anti-Reflection Layer)

In the polarizing membrane, an anti-reflection layer (preferably, a low refractive index layer) is preferably provided on the top surface side of liquid crystal display. The low refractive index layer may be provided on the light-diffusing layer, to reduce loss of light caused by reflection.

The low refractive index layer has a refractive index in the range of 1.35 to 1.45.

The refractive index of the low refractive index layer preferably satisfies the following formula (I):
(mλ/4)×0.7<n₁×d₁<(mλ/4)×1.3 Formula (I):
in which m is a positive odd number (usually 1), n₁ is the refractive index of the low refractive index layer, d₁ is the thickness (nm) of the low refractive index layer, and λ is a wavelength of visible light in the region of 450 to 650 nm.

When the refractive index (n₁) satisfies the formula (I), a certain positive odd number (m) (which is usually 1) satisfying the formula (I) can be found in the above wavelength region.

The low refractive index layer can be made of a fluorine-containing resin prepared by hardening a thermosetting or ionization radiation-setting cross-linkable fluorine-containing compound. The thus-prepared layer has better scratch resistance than a low refractive index layer made of magnesium fluoride or calcium fluoride. The hardened fluorine-containing resin has a refractive index in the range of 1.35 to 1.45. The hardened fluorine-containing resin has a coefficient of kinetic friction preferably in the range of 0.03 to 0.15, and gives a contact angle with water preferably in the range of 90° to 120°.

Examples of the cross-linkable fluorine-containing compound include a perfluoroalkyl-containing silane compound [e.g., (heptadecafluoro-1,1,2,2-tetradecyl)tri-ethoxysilane] and a fluorine-containing copolymer derived from fluorine-containing monomers and monomers introducing cross-linking groups.

Examples of the fluorine-containing monomers include fluoroolefins (e.g., fluoroethylene, vinylidene fluoride, tetrafluoroethylene, hexafluoroethylene, hexafluoropropylene, perfluoro-2,2-dimethyl-1,3-dioxole), partially or completely fluorinated (meth)acrylic alkyl ester derivatives (e.g., Biscoat 6FM [trade name, Osaka Organic Chemicals Co., Ltd.], M-2020 [trade name, Daikin Co., Ltd.], and partially or completely fluorinated vinyl ethers.

Examples of the monomers introducing cross-linking groups include a (meth)acrylate monomer having a cross-linking group (e.g., glycidyl methacrylate), and a (meth)acrylate monomer having carboxyl, hydroxyl, amino or sulfonic acid group (e.g., (meth)acrylic acid, methylol (meth)acrylate, hydroxyalkyl(meth)acrylate, allylic acrylate). After the (meth)acrylate monomers having carboxyl, hydroxyl, amino or sulfonic acid group are copolymerized, cross-linked structure can be formed in the manner described in Japanese Patent Provisional Publication Nos. 10(1998)-25388 and 10(1998)-147739.

As well as the copolymer derived from fluorine-containing monomers and monomers introducing cross-linking groups, a copolymer derived from these monomers and other monomers can be also used for the low refractive index layer.

Examples of the usable monomers other than the above monomers include olefins (e.g., ethylene, propylene, isoprene, vinyl chloride, vinylidene chloride), acrylate esters (e.g., methyl acrylate, ethyl acrylate, 2-ethylhexyl acrylate), methacrylate esters (e.g., methyl methacrylate, ethyl methacrylate, butyl methacrylate, ethylene glycol dimethacrylate), styrene and derivatives thereof (e.g., divinylbenzene, vinyltoluene, α-methylstyrene), vinyl ethers (e.g., methylvinyl ether), vinyl esters (e.g., vinyl acetate, vinyl propionate, vinyl cinnamate), acrylamides (e.g., N-tert-butylacrylamide, N-cyclohexylacrylamide), methacrylamides and acrylonitrile derivatives.

In the fluorine-containing resin used in the low refractive index layer, superfine particles of Si oxide are preferably dispersed to make the layer tough against scratching. The mean size of the Si oxide particles is preferably 0.1 μm or less, more preferably in the range of 0.001 to 0.05 μm. The lower refractive index the fluorine-containing resin has, the more the layer is prevented from reflecting light. However, if the refractive index is too low, the scratching resistance is impaired. Accordingly, the refractive index of the resin and the amount of the Si oxide particles are controlled so adequately that the refractive index and the scratching resistance may be optimally balanced.

As the superfine particles of Si oxide, commercially available silica sol dispersed in an organic solvent can be directly added to a coating solution for forming the low refractive index layer. Otherwise, various commercially available silica powders may be dispersed in an organic solvent to prepare a silica dispersion to use.

In order to increase the adhesion between the low refractive index layer and a layer provided under, monomers reacting with not only the surface of oxide fine particles in the low refractive index layer but also monomers in the underlying layer are preferably used. Examples of that monomer include silane-coupling monomer having acrylate functional group (e.g., KBM5103, the Shin-Etsu Chemical Co., Ltd.) and isocyanate monomer having methylacrylate functional group (e.g., MOI, Showa Denko K.K.).

The anti-reflection layer reflects incident light of 450 to 650 nm coming at the incident angle of 5° preferably in an average mirror reflectance of 2.5% or less. The average mirror reflectance is more preferably 1.2% or less, most preferably 1.1% or less.

The mirror reflectance of light coming at the incident angle of 5° is a ratio of the intensity of light reflected out at the angle of −5° to the normal per the intensity of incident light coming at the angle of +5° to the normal. The mirror reflectance indicates how much the surface reflects surrounding scenes. The anti-glare anti-reflection layer (film) shows a small mirror reflectance because it has a rough surface (which is provided for anti-glare performance) scattering the incident light to reduce the intensity of light reflected at the angle of −5° to the normal. Therefore, the mirror reflectance indicates both anti-reflection character and anti-glare character.

Further, the incident light of 450 to 650 nm coming at the incident angle of 5° is reflected preferably in an integrated reflectance of 2.5% or less. The average integrated reflectance is more preferably 2.3% or less.

The integrated reflectance of light coming at the incident angle of 5° is a ratio of the total intensity of light reflected out in all directions per the intensity of incident light coming at the angle of +5° to the normal. Since it is not reduced by scattered light, the integrated reflectance indicates only anti-reflection character.

The mirror reflectance and the integrated reflectance of light in the wavelength region of 450 to 650 nm coming at the incident angle of 5° are both controlled at 2.5% or less to realize both satisfying anti-reflection character and sufficient anti-glare character.

If the anti-reflection layer reflects light in the wavelength region of 450 to 650 nm coming at the incident angle of 5° in an average mirror reflectance of more than 2.5%, it mirrors surrounding scenes so much that a display equipped with the film gives an image of poor recognizability.

The anti-reflection layer is preferably designed so that the incident light coming at the incident angle of 5° from the CIE standard light source D65 may be reflected to give ortho-reflected light having chromaticity satisfying the conditions of:

L*≦10, 0≦a*≦2, and −5≦b*≦2

in which L*, a* and b* are values in L*a*b* color space of CIE 1976. The reflected light having the above conditions shows neutral chromaticity.

The chromaticity of ortho-reflected light having been emitted from the CIE standard light source D65 and having entered at the incident angle of 5° can be evaluated in terms of the L*, a* and b* values in L*a*b* color space of CIE 1976. The L*, a* and b* values are calculated from the spectral reflection spectrum, which is obtained from the product (at each wavelength) of the measured mirror reflectance of light in the wavelength region of 380 to 780 nm coming at the incident angle of 5° and the intensity (in the spectral distribution) of original light emitted from the light source D65.

If the L* value is 10 or more, the layer (film) cannot fully prevent the display surface from reflecting incident light. If the a* value is more than 2, the reflected light is unnaturally colored in violet. On the other hand, if the a* value is less than 0, the reflected light is unnaturally colored greenly. If the b* value is less than −5, the reflected light is unnaturally colored in blue. On the other hand, if the b* value is more than 2, the reflected light is unnaturally colored in yellow.

The refractive index of the low refractive index layer and that of the binder material for the anti-glare layer are balanced optimally so that the anti-reflection layer (film) may have a low refractive index and may give reflected light having neutral chromaticity.

A known anti-reflection film comprising three or more optical thin layers formed by deposition or spattering can be made to give an average mirror reflectance of 0.3% or less, and accordingly its L* value can be reduced to 3 or less. However, in that case, the a* and b* values are 10 or more and less than −10, respectively. Accordingly, the known film gives unnaturally colored reflected Light. In contrast, the aforementioned anti-glare anti-reflection film is remarkably improved in avoiding the unnatural coloring of reflected light.

### EXAMPLE 1

(Preparation of Polarizing Membrane)

A film of polyvinyl alcohol (average polymerization degree: 4,000, saponification degree: 99.8%) was stretched approx. six times as long as the original length in a hot water at 40° C. The stretched film was immersed in an aqueous solution containing 0.5 g/l of iodine and 50 g/l of potassium iodide at 30° C. for 1 minute, and then immersed in another aqueous solution containing 100 g/l of boric acid and 60 g/l of potassium iodide at 70° C. for 5 minutes. The immersed film was washed with water in a tank at 20° C. for 10 seconds, and dried at 80° C. for 5 minutes. Thus, an iodine polarizing membrane (width: 1,330 mm, depth: 20 μm) was prepared.

(Formation of First Optically Anisotropic Sub-Layer Comprising Discotic Liquid Crystal Molecules Oriented in Homeotropic Alignment)

In methyl ethyl ketone, 90 weight parts of the following discotic liquid crystal compound, 10 weight parts of ethylene oxide denatured trimethlolpropanetriacrylate (V#360, Osaka Organic Chemicals Co., Ltd.), 0.6 weight part of melamine-formaldehyde/acrylic acid copolymer (Aldrich), 3.0 weight parts of a photopolymerization initiator (Irgacure 907, Ciba-Geigy) and 1.0 weight part of a sensitizer (Kayacure DETX, Nippon Kayaku Co., Ltd.) were dissolved to prepare a coating solution (solid content: 38 wt. %).
Discotic Liquid Crystal Compound

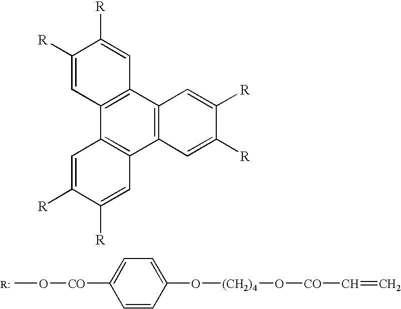

The coating solution was applied on one surface of the polarizing membrane, and dried. Immediately after dried at 130° C. for 1 minute to orient the liquid crystal molecules, the membrane was cooled to room temperature and exposed to ultraviolet light in the amount of 500 mJ/cm² to polymerize the molecules and thereby to fix the alignment. Thus, a first optically anisotropic (sub)layer (thickness: 1.7 μm) was formed.

The angular dependence of retardation in the first optically anisotropic (sub)layer was measured by means of an ellipsometer [M-150, JASCO Corporation]. As a result, it was found that the angle between the long axis (discotic plane) of liquid crystal molecule and the surface of membrane was 0.2° on average and that the retardation value along the thickness (Rth) was 88 nm.

(Formation of Orientation Layer)

On the first optically anisotropic (sub)layer comprising discotic liquid crystal molecules oriented in homeotropic alignment, a coating solution of the following composition was applied in the amount of 28 ml/m² by means of a wire bar coater of #16. The applied solution was dried with hot air at 60° C. for 60 seconds, and then further dried with hot air at 90° C. for 150 seconds. The formed layer was subjected to the rubbing treatment, to form an orientation layer.

Coating solution for orientation layer

| | |
|---|---|
| The following denatured polyvinyl alcohol | 10 weight parts |
| Water | 371 weight parts |
| Methanol | 119 weight parts |
| Glutaric aldehyde (cross-linking agent) | 0.5 weight part |

(Denatured polyvinyl alcohol)

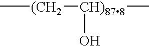

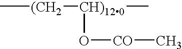

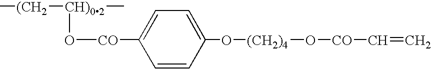

(Formation of Second Optically Anisotropic (Sub)Layer Comprising Discotic Liquid Crystal Molecules Oriented in Hybrid Alignment)

To prepare another coating solution, 41.01 g of the above discotic liquid crystal compound, 4.06 g of ethylene oxide denatured trimethlolpropanetriacrylate (V#360, Osaka Organic Chemicals Co., Ltd.), 0.35 g of cellulose acetate butyrate (CAB-531-1, Eastman Chemical), 1.35 g of a photopolymerization initiator (Irgacure 907, Ciba-Geigy) and 0.45 g of a sensitizer (Kayacure DETX, Nippon Kayaku Co., Ltd.) were dissolved in 102 g of methyl ethyl ketone.

The coating solution was then applied on the orientation layer by means of a wire bar coater of #3. The thus-treated film was fixed on a metal frame, and maintained in a thermostat at 130° C. for 2 minutes to align the molecules of the discotic liquid crystal compound. The film was then irradiated at 130° C. for 1 minute with ultraviolet rays emitted from a high-pressure mercury lamp of 120 W/cm, to polymerize the discotic molecules. The film was cooled to room temperature to form a second optically anisotropic (sub) layer.

The Re retardation value of the second optically anisotropic (sub)layer was measured at 546 nm, and found 38 nm. The angle between the long axis (discotic plane) of liquid crystal molecule and the surface of membrane was 40° on average.

(Preparation of TN-Mode Polarizing Plate)

On the opposite surface of polarizing membrane (on which the optically anisotropic sub-layers were not provided), a triacetyl cellulose film (thickness: 80 μm, Fuji Photo Film Co., Ltd.) was laminated with polyvinyl alcoholic adhesive and then dried at 60° C. for 15 minutes to prepare a polarizing plate.

(Preparation of Liquid Crystal Display)

A pair of polarizing plates was removed from a commercially available liquid crystal display of TN mode (AQUEOUS•LC20C1S, Sharp Corporation). In place of the removed polarizing plates, the above-prepared polarizing plate was laminated on each surface with adhesive so that the optically anisotropic layer might be on the liquid crystal cell side. The polarizing plate on the surface of the observer side and that on the other surface of the backlight side were placed so that the transmission axes of the plates might be arranged in O mode. Thus, the liquid crystal display was prepared.

The viewing angle of the prepared liquid crystal display was measured by means of a measuring apparatus (EZ-Contrast 160D, ELDIM) when each of the eight tones of black (L1) to white (L8) was displayed. The results are set forth in Table 1.

### EXAMPLE 2

(Preparation of Cellulose Acetate Film)

The dopes for preparation of inner and surface layers comprising the following components were prepared by the normal dissolution process. The used cellulose acetate had the acetic acid content of 60.7%.

| Cellulose acetate dope | | |
|---|---|---|
| | Inner layer | Surface layer |

| | | | | |
|---|---|---|---|---|
| Cellulose acetate | 100 | weight parts | 100 | weight parts |
| Triphenyl phosphate | 7.8 | weight parts | 7.8 | weight parts |
| Biphenyldiphenyl | 3.9 | weight parts | 3.9 | weight parts |
| phosphate | | | | |
| Benzophenone UV | 0.7 | weight part | 0.7 | weight part |
| absorber | | | | |
| Methylene chloride | 450 | weight parts | 481 | weight parts |
| Methanol | 39 | weight parts | 42 | weight parts |

The prepared dope for surface layer was filtered at 50° C. through a filter paper (absolute filtration precision: 0.0025 mm, FH025 PALL CORPORATION), and that for inner layer was filtered at 50° C. through another filter paper (absolute filtration precision: 0.01 mm, #63 TOYO ROSHI KAISHA LTD.).

The prepared dopes were simultaneously extruded onto a metal support from a three-layer co-casting die, so that the dope for inner layer might be sandwiched with that for surface layer. The dry thickness of the inner layer was 48 μm, and that of each surface layer was 6 μm. After dried at 70° C. for 3 minutes and further at 120° C. for 5 minutes, the formed film was peeled from the support and furthermore dried at 130° C. for 30 minutes to evaporate the solvent. Thus, a cellulose acetate film was prepared. The solvent remaining in the film was 0.9%. The surface roughness of the film per 100 mm was measured at ten points randomly selected in the lateral direction, to find 0.13 μm on average.

(Formation of Light-Diffusing Layer)

In a mixed solvent of methyl ethyl ketone/methyl isobutyl ketone (20/80, by weight), 100 weight parts of zirconium oxide-dispersed hard coat liquid (Desolite KZ-7114A, JSR Co., Ltd.), 43 weight parts of transparent resin (DPHA, Nippon Kayaku Co., Ltd.) and 5 weight parts of hardening initiator (Irgacure 184, Ciba-Geigy) were mixed and dissolved with stirring by means of air-disperser. The prepared liquid was applied, dried, and then exposed to ultraviolet light to harden the layer. The thus-formed layer had the refractive index of 1.64.

To the above prepared liquid, 30 weight parts of polymethymethacylate beads (MX150, Soken Kagaku Co., Ltd.; particles size: 1.5 μm; refractive index: 1.53) as the transparent fine particles were mixed and dispersed. The solid content of the mixture was controlled with methyl ethyl ketone/methyl isobutyl ketone (20/80, by weight) at 53 wt. %. The thus-prepared liquid was applied on the cellulose acetate film to form a layer having the dry thickness of 4.0 μm. The formed film was dried, and then exposed to ultraviolet light (illuminance: 400 mW/cm², exposure: 300 mJ/cm²) emitted from an air-cooled metal halide lamp of 160 W/cm (Eyegraphics Co., Ltd.) to harden. Thus, a light-diffusing layer was prepared.

For measuring the haze value of the light-diffusing layer, the above-procedure was repeated to form the layer on a glass plate. The haze value of the thus-formed layer was determined by means of a haze meter (MODEL 1001DP, Nippon Denshoku kogyo Co., Ltd.) according to JIS-K-7105. As a result, it was found that the haze was 59%.

(Formation of Low Refractive Index Layer)

Into 2,240 g of a thermo-cross-linkable fluorine-containing polymer (JN-7228, JSR Co., Ltd.; refractive index: 1.42, solid content: 6 wt. %, in the form of methyl ethyl ketone solution), 192 g of SiO₂ sol dispersed in methyl ethyl ketone (MEK-ST, Nissan Chemicals Co., Ltd.; solid content: 30 wt. %, particle size of SiO₂: 10 to 20 nm), 2,224 g of methyl ethyl ketone and 144 g of cyclohexanone were added and stirred. The obtained liquid was filtrated through a propylene filter (PPE-01, porous size: 1 μm) to prepare a coating solution for low refractive index layer.

The prepared coating solution was applied on the light-diffusing layer by means of a bar coater, dried at 80° C., and further heated at 120° C. for 8 minutes to cross-link. Thus, a low refractive index layer (thickness: 0.096 μm) was formed. The formed low refractive index layer had the average integrated reflectance of 1.25%.

(Preparation of TN-Mode Polarizing Plate)

The procedure for preparation of the polarizing plate in Example 1 was repeated except that, in place of the triacetyl cellulose film (thickness: 80 μm, Fuji Photo Film Co., Ltd.), the above-prepared cellulose acetate film provided with the light-diffusing layer and the low refractive index layer was laminated so that the cellulose acetate film might be on the membrane side, and dried at 60° C. for 15 minutes. Thus, a polarizing plate was prepared.

(Preparation of Liquid Crystal Display)

A pair of polarizing plates was removed from a commercially available liquid crystal display of TN mode (AQUEOUS•LC20C1S, Sharp Corporation). In place of the removed polarizing plates, the above-prepared polarizing plate was laminated on the observer side surface with adhesive so that the optically anisotropic layer might be on the liquid crystal cell side. On the backlight side, the polarizing plate prepared in Example 1 was laminated in the same manner as in Example 1. The polarizing plate on the observer side and that on the backlight side were placed so that the transmission axes of the observer side plate and the backlight side plate might be arranged in O mode. Thus, the liquid crystal display was prepared.

The viewing angle of the prepared liquid crystal display was measured by means of a measuring apparatus (EZ-Contrast 160D, ELDIM) when each of the eight tones of black (L1) to white (L8) was displayed. The results are set forth in Table 1.

### COMPARISON EXAMPLE 1

The viewing angle of a commercially available liquid crystal display of TN mode (AQUEOUS•LC20C1S, Sharp Corporation) was measured by means of a measuring apparatus (EZ-Contrast 160D, ELDIM) when each of the eight tones of black (L1) to white (L8) was displayed. The results are set forth in Table 1.

TABLE 1

| | Liquid crystal display | | |
|---|---|---|---|
| | Viewing angle giving a contrast ratio of 10 or | | |
| | more without reversing gray scale gradation | | |
| | Upward | Downward | Left-rightward |
| Example 1 | 75° | 43° | 80° |
| Example 2 | 80° | 60° | 80° |
| Comp. Ex. 1 | 70° | 42° | 80° |

Remark:
Gray scale gradation: reverse between L1 and L2

(Evaluation on Framewise Light-Leakage)

The backlight of each prepared display was continuously kept on for 5 hours under the condition of 25° C. and 60% RH. After that, a black image displayed on each display was observed by the eyes in a dark room to check whether light framewise leaked through the screen or not. As a result, the leakage was not seen in the displays of Examples 1 and 2, but was observed in the display of Comparison Example 1.

(Evaluation on Blur of Image)

A white letter (font size: 6) on a black background was displayed on each display, and observed to evaluate how blurry images the display gave. As a result, there was no difference among the displays of Examples 1, 2 and Comparison Example 1. In a bright room, the display of Example 2 gave the clearest image because it reflected the surrounding scene the least.

### EXAMPLE 3

(Preparation of Polarizing Membrane)

A film of polyvinyl alcohol (average polymerization degree: 2,500, saponification degree: 99.5 mol. %) was stretched. The stretched film was immersed in an aqueous solution containing 0.2 g/l of iodine and 60 g/l of potassium iodide at 30° C. for 5 minutes. The film was then further stretched obliquely at the angle of 45° while immersed in another aqueous solution containing 100 g/l of boric acid and 30 g/l of potassium iodide at 60° C. for 10 minutes. The width of the film was 1,500 mm, and the thickness at the right and left side was equally 15 μm.

The film was washed with water in a tank at 20° C. for 10 seconds, immersed in an aqueous solution containing 0.1 g/l of iodine and 20 g/l of potassium iodide at 30° C. for 15 seconds, and dried at room temperature for 24 hours. Thus, an iodine polarizing membrane was prepared.

(Formation of First Optically Anisotropic (Sub)Layer Comprising Discotic Liquid Crystal Molecules Oriented in Homeotropic Alignment)

In methyl ethyl ketone, 90 weight parts of the discotic liquid crystal compound used in Example 1, 10 weight parts of ethylene oxide denatured trimethlolpropanetriacrylate (V#360, Osaka Organic Chemicals Co., Ltd.), 0.6 weight part of melamine-formaldehyde/acrylic acid copolymer (Aldrich), 3.0 weight parts of a photopolymerization initiator (Irgacure 907, Ciba-Geigy) and 1.0 weight part of a sensitizer (Kayacure DETX, Nippon Kayaku Co., Ltd.) were dissolved to prepare a coating solution (solid content: 38 wt. %).

The coating solution was applied on one surface of the polarizing membrane, and dried. Immediately after dried at 130° C. for 1 minute to orient the liquid crystal molecules, the membrane was cooled to room temperature and exposed to ultraviolet light in the amount of 500 mJ/cm² to polymerize the molecules and thereby to fix the alignment. Thus, a first optically anisotropic (sub)layer (thickness: 3.1 μm) was formed.

The angular dependence of retardation in the first optically anisotropic (sub)layer was measured by means of the ellipsometer [M-150, JASCO Corporation]. As a result, it was found that the angle between the long axis (discotic plane) of liquid crystal molecule and the surface of membrane was 0.5° on average and that the retardation value along the thickness (Rth) was 175 mm.

(Formation of Orientation Layer)

The first optically anisotropic (sub)layer was subjected to the corona discharge treatment, and then coated with a 2 wt. % solution of denatured polyimide (Nissan Chemicals Co., Ltd.) and dried. The formed layer (thickness: 0.5 μm) was then subjected to the rubbing treatment, to form an orientation layer.

(Formation of Second Optically Anisotropic (Sub)Layer Comprising Rod-Like Liquid Crystal Molecules Oriented in Homogeneous Alignment)

In 80 weight parts of tetrachloroethane, 20 weight parts of acrylic thermotropic liquid crystal polymer was dissolved to prepare a coating solution.

The coating solution was then applied on the orientation layer, heated at 160° C. for 5 minutes, and cooled to room temperature to fix the alignment of the liquid crystal molecules. The thus-formed second optically anisotropic (sub)layer had the thickness of 0.5 μm.

The retardation was measured at 633 nm by means of an ellipsometer [M-150, JASCO Corporation]. As a result, it was found that the angle between the long axis of rod-like liquid crystal molecule and the surface of membrane was 0.8° on average and that the retardation values in the plane (Re) and along the thickness (Rth) were 40 nm and 175 nm, respectively.

(Formation of Orientation Layer)

On the second optically anisotropic (sub)layer, a coating solution of the following composition was applied in the amount of 28 ml/m² by means of a wire bar coater of #16. The applied solution was dried with hot air at 60° C. for 60 seconds, and then further dried with hot air at 90° C. for 150 seconds. The formed layer was subjected to the rubbing treatment at the angle of 45° to the rubbing direction of the second anisotropic (sub)layer, to form an orientation layer.

Coating solution for orientation layer

| | | |
|---|---|---|
| The denatured polyvinyl | 10 | weight parts |
| alcohol used in Example 1 | | |
| Water | 371 | weight parts |
| Methanol | 119 | weight parts |
| Glutaric aldehyde (cross-linking agent) | 0.5 | weight part |

(Formation of Third Optically Anisotropic (Sub)Layer Comprising Discotic Liquid Crystal Molecules Oriented in Hybrid Alignment)

To prepare another coating solution, 41.01 g of the discotic liquid crystal compound used in Example 1, 4.06 g of ethylene oxide denatured trimethlolpropanetriacrylate (V#360, Osaka Organic Chemicals Co., Ltd.), 0.17 g of cellulose acetate butyrate (CAB-531-1, Eastman Chemical), 1.35 g of a photopolymerization initiator (Irgacure 907, Ciba-Geigy) and 0.45 g of a sensitizer (Kayacure DETX, Nippon Kayaku Co., Ltd.) were dissolved in 102 g of methyl ethyl ketone.

The coating solution was then applied on the orientation layer by means of a wire bar coater of #3.6. The thus-treated film was heated in a thermostat at 130° C. for 2 minutes to align the molecules of the discotic liquid crystal compound. The film was then irradiated at 60° C. for 1 minute with ultraviolet rays emitted from a high-pressure mercury lamp of 120 W/cm, to polymerize the discotic molecules. The film was cooled to room temperature to form a third optically anisotropic (sub)layer.

The Re retardation value of the third optically anisotropic (sub)layer was measured at 546 nm, and found 43 nm. The angle between the long axis (discotic plane) of liquid crystal molecule and the surface of membrane was 32° on average.

(Preparation of OCB-Mode Polarizing Plate)

On the opposite surface of polarizing membrane (on which the optically anisotropic sub-layers were not provided), a triacetyl cellulose film (thickness: 80 μm, Fuji Photo Film Co., Ltd.) was laminated with polyvinyl alcoholic adhesive and then dried at 60° C. for 15 minutes to prepare a polarizing plate.

(Preparation of Liquid Crystal Display)

On a glass plate having an ITO electrode, an orientation film of polyimide was provided and subjected to a rubbing treatment. This procedure was repeated to prepare two substrates, and the substrates were arranged face-to-face so that the rubbing directions might be parallel and that the gap might be 6 μm. Between them, a liquid crystal having Δn of 0.1396 (ZLI1132, Merck & Co., Inc.) was introduced to prepare a liquid crystal cell of bend alignment. The size of the cell was 20 inches.

Two polarizing plates prepared above were laminated on the liquid crystal cell so that the cell might be between the plates. The plates were arranged so that the optically anisotropic layer in each plate might face to the cell substrate and that the rubbing directions of the cell and the optically anisotropic layer might be anti-parallel.

Voltage of a square wave (55 Hz) was applied to the liquid crystal cell. An image was displayed according to normally white mode (white: 2V, black: 5V). A ratio of contrast (white/black) was measured by means of a meter (EZ-Contrast 160D, ELDIM) at eight displaying states of L1 (full black) to L8 (full white). From the obtained contrast ratio, the viewing angle was measured. The results are set forth in Table 2.

TABLE 2

| | Liquid crystal display | | |
|---|---|---|---|
| | Viewing angle giving a contrast ratio of 10 or | | |
| | more without reversing gray scale gradation | | |
| | Upward | Downward | Left-rightward |
| Example 3 | 80° | 80° | 80° |

Remark:
Gray scale gradation: reverse between L1 and L2

(Evaluation on Framewise Light-Leakage)

The backlight of the prepared display was continuously kept on for 5 hours under the condition of 25° C. and 60% RH. After that, a black image displayed on the display was observed by the eyes in a dark room to check whether light framewise leaked through the screen or not. As a result, the leakage was not seen.

### EXAMPLE 4

(Preparation of Polarizing Membrane)

A film of polyvinyl alcohol (average polymerization degree: 1,700, saponification degree: 99.5 mol. %) was monoaxially stretched in the longitudinal direction approx. eight times as long as the original length in a hot water at 40° C. The stretched film was immersed in an aqueous solution containing 0.2 g/l of iodine and 60 g/l of potassium iodide at 30° C. for 5 minutes, and then immersed in another aqueous solution containing 100 g/l of boric acid and 30 g/l of potassium iodide. The width of the film was 1,300 mm, and the thickness was 17 μm.

The immersed film was washed with water in a tank at 20° C. for 10 seconds, immersed in an aqueous solution containing 0.1 g/l of iodine and 20 g/l of potassium iodide at 30° C. for 15 seconds, and dried at room temperature for 24 hours. Thus, an iodine polarizing membrane was prepared.

(Formation of First Optically Anisotropic (Sub)Layer Comprising Discotic Liquid Crystal Molecules Oriented in Homeotropic Alignment)

In methyl ethyl ketone, 90 weight parts of the discotic liquid crystal compound used in Example 1, 10 weight parts of ethylene oxide denatured trimethlolpropanetriacrylate (V#360, Osaka Organic Chemicals Co., Ltd.), 0.6 weight part of melamine-formaldehyde/acrylic acid copolymer (Aldrich), 3.0 weight parts of a photopolymerization initiator (Irgacure 907, Ciba-Geigy) and 1.0 weight part of a sensitizer (Kayacure DETX, Nippon Kayaku Co., Ltd.) were dissolved to prepare a coating solution (solid content: 38 wt. %).

The coating solution was applied on one surface of the polarizing membrane, and dried. Immediately after dried at 130° C. for 1 minute to orient the liquid crystal molecules, the membrane was cooled to room temperature and exposed to ultraviolet light in the amount of 500 mJ/cm² to polymerize the molecules and thereby to fix the alignment. Thus, a first optically anisotropic (sub)layer (thickness: 2.8 μm) was formed.

The angular dependence of retardation in the first optically anisotropic (sub)layer was measured by means of the ellipsometer [M-150, JASCO Corporation]. As a result, it was found that the angle between the long axis (discotic plane) of liquid crystal molecule and the surface of membrane was 0.3° on average and that the retardation value along the thickness (Rth) was 150 nm.

(Formation of Orientation Layer)

The first optically anisotropic (sub)layer was subjected to the corona discharge treatment, and then coated with a 2 wt. % solution of denatured polyimide (Nissan Chemicals Co., Ltd.) and dried. The formed layer (thickness: 0.5 μm) was then subjected to the rubbing treatment, to form an orientation layer.

(Formation of Second Optically Anisotropic (Sub)Layer Comprising Rod-Like Liquid Crystal Molecules Oriented in Homogeneous Alignment)

In 80 weight parts of tetrachloroethane, 20 weight parts of acrylic thermotropic liquid crystal polymer was dissolved to prepare a coating solution.

The coating solution was then applied on the orientation layer, heated at 160° C. for 5 minutes, and cooled to room temperature to fix the alignment of the liquid crystal molecules. The thus-formed second optically anisotropic (sub)layer has the thickness of 0.7 μm.

The retardation was measured by means of an ellipsometer [M-150, JASCO Corporation] at 633 nm. As a result, it was found that the angle between the long axis of rod-like liquid crystal molecule and the surface of membrane was 0.4° on average and that the retardation values in the plane (Re) and along the thickness (Rth) were 45 nm and 150 nm, respectively.

(Preparation of VA-Mode Polarizing Plate)

On the opposite surface of polarizing membrane (on which the optically anisotropic sub-layers were not provided), a triacetyl cellulose film (thickness: 80 μm, Fuji Photo Film Co., Ltd.) was laminated with polyvinyl alcoholic adhesive and then dried at 60° C. for 15 minutes to prepare a polarizing plate.

(Preparation of Liquid Crystal Display)

A pair of polarizing plates and a pair of optical compensatory sheets were removed from a commercially available liquid crystal display (VL-1530S, Fujitsu, Ltd.), which has a liquid crystal cell comprising vertically aligned liquid crystal molecules. In place of the removed members, the above-prepared polarizing plate was laminated on each of the observer and backlight sides of the cell with an adhesive so that the optically anisotropic layer might be on the liquid crystal cell side. The polarizing plate on the observer side was placed so that the transmission axis might be in the up-down direction, while the plate on the backlight side was placed so that the transmission axis might be in the left-right direction. Thus, the polarizing plates were arranged in cross-Nicol position.

The viewing angle of the prepared liquid crystal display was measured by means of a measuring apparatus (EZ-Contrast 160D, ELDIM) when each of eight tones of black (L1) to white (L8) was displayed. The results are set forth in Table 3.

### COMPARISON EXAMPLE 2

The viewing angle of a commercially available liquid crystal display (VL-1530S, Fujitsu, Ltd.), which has a liquid crystal cell comprising vertically aligned liquid crystal molecules, was measured by means of a measuring apparatus (EZ-Contrast 160D, ELDIM) when each of the eight tones of black (L1) to white (L8) was displayed. The results are set forth in Table 3.

TABLE 3

| | Liquid crystal display | |
|---|---|---|
| | Viewing angle giving a contrast ratio of 10 or | |
| | more without reversing gray scale gradation | |
| | Along the transmission axis | At 45° to transmission axis |
| Example 4 | >80° | >80° |
| Comp. Ex. 2 | >80° | 44° |

Remark:
Gray scale gradation: reverse between L1 and L2

(Evaluation on Framewise Light-Leakage)

The backlight of each prepared display was continuously kept on for 5 hours under the condition of 25° C. and 60% RH. After that, a black image shown on each display was observed by the eyes in a dark room to check whether light framewise leaked through the screen or not. As a result, the leakage was not seen in the display of Example 4, but was observed in the display of Comparison Example 2.

1. A polarizing plate comprising a polarizing membrane and an optically anisotropic layer formed from liquid crystal molecules, wherein the optically anisotropic layer is formed on the polarizing membrane, or wherein an orientation layer is formed on the polarizing membrane, and the optically anisotropic layer is formed on the orientation layer.

2. The polarizing plate as defined in claim 1, wherein the liquid crystal molecules in the optically anisotropic layer are rod-like liquid crystal molecules, and wherein long axes of the rod-like liquid crystal molecules are oriented at an angle of more than 5° on average to a surface of the polarizing membrane.

3. The polarizing plate as defined in claim 2, wherein the long axes of the rod-like liquid crystal molecules are oriented at an angle of less than 5° on average to a transmission axis of the polarizing membrane.

4. The polarizing plate as defined in claim 1, wherein the liquid crystal molecules in the optically anisotropic layer are discotic liquid crystal molecules, and wherein discotic planes of the discotic liquid crystal molecules are oriented at an angle of less than 5° on average to a surface of the polarizing membrane.

5. The polarizing plate as defined in claim 1, wherein the polarizing membrane has a thickness of 20 μm or less.

6. The polarizing plate as defined in claim 1, which further comprises a light-diffusing layer.

7. The polarizing plate as defined in claim 1, which further comprises an anti-reflection layer.

8. The polarizing plate as defined in claim 7, which further comprises a transparent support having a thickness of 70 μm or less, and the anti-reflection layer is provided on the transparent support.

9. The polarizing plate as defined in claim 1, wherein the optically anisotropic layer comprises a first optically anisotropic layer formed on the polarizing membrane and a second optically anisotropic layer formed on the first optically anisotropic layer, and wherein long axes or discotic planes of the liquid crystal molecules in the first optically anisotropic layer are oriented at an angle of more than 10° on average to a direction in which long axes or discotic planes of the liquid crystal molecules in the second optically anisotropic layer are oriented on average.

10. The polarizing plate as defined in claim 9, wherein the liquid crystal molecules in the first optically anisotropic layer are rod-like liquid crystal molecules, and wherein long axes of the rod-like liquid crystal molecules are oriented at an angle of less than 5° on average to a surface of the polarizing membrane.

11. The polarizing plate as defined in claim 10, wherein the long axes of the rod-like liquid crystal molecules are oriented at an angle of less than 5° on average to a transmission axis of the polarizing membrane.

12. The polarizing plate as defined in claim 10, wherein the liquid crystal molecules in the second optically anisotropic layer are rod-like liquid crystal molecules, wherein long axes of the rod-like liquid crystal molecules are oriented at an angle of more than 15° on average to a surface of the polarizing membrane, and wherein an angle between the long axis of each rod-like liquid crystal molecule and the surface of the polarizing membrane varies according to a distance between the rod-like liquid crystal molecule and the polarizing membrane.

13. The polarizing plate as defined in claim 10, wherein the liquid crystal molecules in the second optically anisotropic layer are discotic liquid crystal molecules, wherein discotic planes of the discotic liquid crystal molecules are oriented at an angle of more than 15° on average to a surface of the polarizing membrane, and wherein an angle between the discotic plane of each discotic liquid crystal molecule and the surface of the polarizing membrane varies according to the distance between the discotic liquid crystal molecule and the polarizing membrane.

14. The polarizing plate as defined in claim 11, wherein the liquid crystal molecules in the second optically anisotropic layer are rod-like liquid crystal molecules, wherein long axes of the rod-like liquid crystal molecules are oriented at an angle of less than 5° on average to a surface of the polarizing membrane, and wherein the long axes of the rod-like liquid crystal molecules are oriented at an angle of less than 5° on average to a transmission axis of the polarizing membrane.

15. The polarizing plate as defined in claim 10, wherein the liquid crystal molecules in the second optically anisotropic layer are discotic liquid crystal molecules, and wherein discotic planes of the discotic liquid crystal molecules are oriented at an angle of more than 85° on average to a surface of the polarizing membrane.

16. The polarizing plate as defined in claim 9, wherein the liquid crystal molecules in the first optically anisotropic layer are discotic liquid crystal molecules, and wherein discotic planes of the discotic liquid crystal molecules are oriented at an angle of more than 5° on average to a surface of the polarizing membrane.

17. The polarizing plate as defined in claim 16, wherein the liquid crystal molecules in the second optically anisotropic layer are rod-like liquid crystal molecules, wherein long axes of the rod-like liquid crystal molecules are oriented at an angle of more than 15° on average to a surface of the polarizing membrane, and wherein an angle between the long axis of each rod-like liquid crystal molecule and the surface of the polarizing membrane varies according to the distance between the rod-like liquid crystal molecule and the polarizing membrane.

18. The polarizing plate as defined in claim 16, wherein the liquid crystal molecules in the second optically anisotropic layer are discotic liquid crystal molecules, wherein discotic planes of the discotic liquid crystal molecules are oriented at an angle of more than 15° on average to a surface of the polarizing membrane, and wherein an angle between the discotic plane of each discotic liquid crystal molecule and the surface of the polarizing membrane varies according to the distance between the discotic liquid crystal molecule and the polarizing membrane.

19. The polarizing plate as defined in claim 16, wherein the liquid crystal molecules in the second optically anisotropic layer are rod-like liquid crystal molecules, and wherein long axes of the rod-like liquid crystal molecules are oriented at an angle of less than 5° on average to a surface of the polarizing membrane.

20. The polarizing plate as defined in claim 19, wherein the long axes of the rod-like liquid crystal molecules are oriented at an angle of less than 5° on average to a transmission axis of the polarizing membrane.

21. The polarizing plate as defined in claim 9, wherein the first optically anisotropic layer functions as an orientation layer of the second optically anisotropic layer.

22. A liquid crystal display comprising a liquid crystal cell and a polarizing plate defined in claim 1.

23. A process for preparation of a polarizing plate comprising a polarizing membrane and an optically anisotropic layer, which comprises a step of coating a coating solution containing liquid crystal molecules on a surface of the polarizing membrane to form the optically anisotropic layer.

24. A process for preparation of a polarizing plate comprising a polarizing membrane and an optically anisotropic layer, which comprises steps of forming an orientation layer on a surface of the polarizing membrane and coating a coating solution containing liquid crystal molecules on a surface of the orientation layer to form the optically anisotropic layer.
